(19) United States
(12) Patent Application Publication
(10) Pub. No.: US 2014/0330749 A1
(43) Pub. Date: Nov. 6, 2014

(54) ASSET LIFECYCLE MANAGEMENT

(71) Applicant: International Business Machines Corporation, Armonk, NY (US)

(72) Inventors: Mehmet F. Candas, Croton On Hudson, NY (US); Arun Hampapur, Norwalk, CT (US); Tarun Kumar, Mohegan Lake, NY (US); Shilpa N. Mahatma, Mohegan Lake, NY (US)

(73) Assignee: International Business Machines Corporation, Armonk, NY (US)

(21) Appl. No.: 13/967,451

(22) Filed: Aug. 15, 2013

Related U.S. Application Data
(63) Continuation of application No. 13/874,610, filed on May 1, 2013.

(51) Int. Cl. G06Q 40/00

(52) U.S. Cl. CPC G06Q 40/06
USPC 705/36 R

(57) ABSTRACT

Embodiments of the invention relate to asset lifecycle management. A method includes assessing a current health condition of a plurality of assets that are managed by a plurality of different entities. Predictive analytics are applied to determine a predicted future health condition of the assets. Prescription options for the assets are determined based on the current health condition and the predicted future health condition of the assets. Each prescription option specifies an asset, a timeframe, an expected cost, and an expected future health condition of the asset. Spatial and temporal analytics are performed to combine individual prescription options into a unified project. The unified project includes prescription options that specify assets that are managed by at least two of the entities. A timeframe to execute the unified project is determined based on financial constraints and spatial constraints. The unified project plan is output.

### CROSS-REFERENCE TO RELATED APPLICATION

This application is a continuation of U.S. patent application Ser. No. 13/874,610, filed May 1, 2013, the content of which is incorporated by reference herein in its entirety.

### BACKGROUND

The present invention relates generally to asset lifecycle management, and more specifically, to planning analytics for asset lifecycle management.

Municipal asset management refers to managing the assets of an entity, such as a city or an agency within a city, in an attempt to maximize the value of the assets over their lifecycle. By managing assets across agencies with a municipality, the municipality can work towards improving their return on assets (ROA) by increasing utilization and performance of assets, reducing capital costs of assets, reducing asset related operating costs, and extending asset life. Capital investment planning for a city agency is a complex process. Given budget shortfalls, cities often need to identify the right investment strategies while considering available financial resources, political drivers, sustainability needs, and public perception. Budget planning for municipal infrastructures can include short term planning (e.g., 1-5 years) and long term planning (e.g., 5-50 years). City agencies are often under pressure to provide improved quality of service to their citizens even in the face of on-going budget cuts. Budget shortfalls often lead to a decision to delay the replacement, repair and/or rehabilitation of assets. These delays may eventually result in one or more of a spike in the failure of assets, an increase in the average age of assets and/or a lower quality of service.

### BRIEF SUMMARY

Embodiments include a method, computer program product, and system for providing lifecycle management. The method includes assessing a current health condition of a plurality of assets that are managed by a plurality of different entities. Predictive analytics are applied to determine a predicted future health condition of the assets. Prescription options for the assets are determined based on the current health condition and the predicted future health condition of the assets. Each prescription option specifies an asset, a timeframe, an expected cost, and an expected future health condition of the asset. Spatial and temporal analytics are performed to combine individual prescription options into a unified project. The unified project includes prescription options that specify assets that are managed by at least two of the entities. A timeframe to execute the unified project is determined based on financial constraints and spatial constraints. The unified project plan is output.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an overview of a process for performing capital planning in accordance with an embodiment;

FIG. 2 depicts possible drivers of a capital planning process in accordance with an embodiment;

FIG. 3 functions provided by a planning analytics for asset lifecycle management tool in accordance with an embodiment;

FIG. 4 depicts a block diagram that maps phases of asset lifecycle planning to key business questions answered by each phase in accordance with an embodiment;

FIG. 5 depicts a block diagram that maps phases of asset lifecycle planning to functions in accordance with an embodiment;

FIG. 6 depicts an end-to-end process flow for capital planning in accordance with an embodiment;

FIG. 7 depicts a methodology for capital planning that may be implemented by an embodiment;

FIG. 8 depicts a system for performing lifecycle management of city assets in accordance with an embodiment;

FIG. 9 depicts a user interface of an infrastructure profiling module in accordance with an embodiment;

FIG. 10 depicts a user interface of a predictive performance asset module in accordance with an embodiment;

FIG. 11 depicts a user interface of a needs assessment module in accordance with an embodiment;

FIG. 12 depicts a user interface of a project identification module in accordance with an embodiment;

FIG. 13 depicts a user interface of an investment planning module in accordance with an embodiment;

FIG. 14 depicts a table that classifies planning actions in accordance with an embodiment;

FIG. 15 depicts a graph that shows the lifecycle for assets in accordance with an embodiment;

FIG. 16 depicts a graph that shows underlying analytics that are input into planning phased in accordance with an embodiment; and

FIG. 17 depicts a computer system for providing asset lifecycle management in accordance with an embodiment.

### DETAILED DESCRIPTION

Embodiments provide an innovative approach to cross agency planning by bringing together the concept of total lifecycle management of city infrastructures using descriptive, predictive, and prescriptive analytics. Embodiments include three pillars: asset performance analysis, strategic needs assessment, and investment planning. Asset performance analysis may include cross agency predictive and quantitative analysis of the current performance of a city infrastructure, along with a scoring framework to enable identifying low performing assets. Strategic needs assessment may include identifying short term (e.g., one to five years) and long term (e.g., ten to one-hundred years) investment candidates, and performing sustainability analysis. Investment planning may include performing comprehensive planning for optimal operation and capital management. Embodiments described herein may be referred to herein as a planning analytics for asset lifecycle management (PALM) tool.

Embodiments support the need for city agencies to optimize the overall health of all infrastructures (road, water, storm, sewer, etc.) by breaking down the complexity of planning for the infrastructure using advanced predictive analytics, asset health assessment, cross agency project identification, sustainability analysis, and investment planning. Components of embodiments may be used in a stand-alone manner or in combination with other components. For example, an embodiment of the PALM tool may include components such as: data model, data ingest, user interface (UI), analytics, and reporting. Each of these components may be used alone or in combination with one or more other components. This may be useful when an agency needs just one component to be integrated into an existing computer application environment or as part of a migration path to other components of the PALM tool.

Embodiments may be utilized to perform a capital planning process that maximizes the life of assets for a fixed amount of money spent (i.e., maximize return on investment or “ROI”) while reducing the backlog of work. In addition, embodiments may be utilized in the capital planning process to come up with a plan that keeps the average remaining life of the assets constant and/or that minimizes the risk of failure of assets. Embodiments described herein include the ability to produce: a two year capital project plan (e.g., for a city council), a three to five year capital project plan (e.g., for a planning team), a ten year capital forecast, a thirty year capital projection, and a one-hundred year capital sustainable outlook.

Benefits to using embodiments of the PALM tool may include, but are not limited to: reducing the effort needed to create capital plans, improving quality of plans, ensuring continuity of planning, tracking of results from one year to the next, ability to manage and re-optimize the system based on changes to the plan, new funding sources being made available, consistency in planning from one year to next, and look ahead planning.

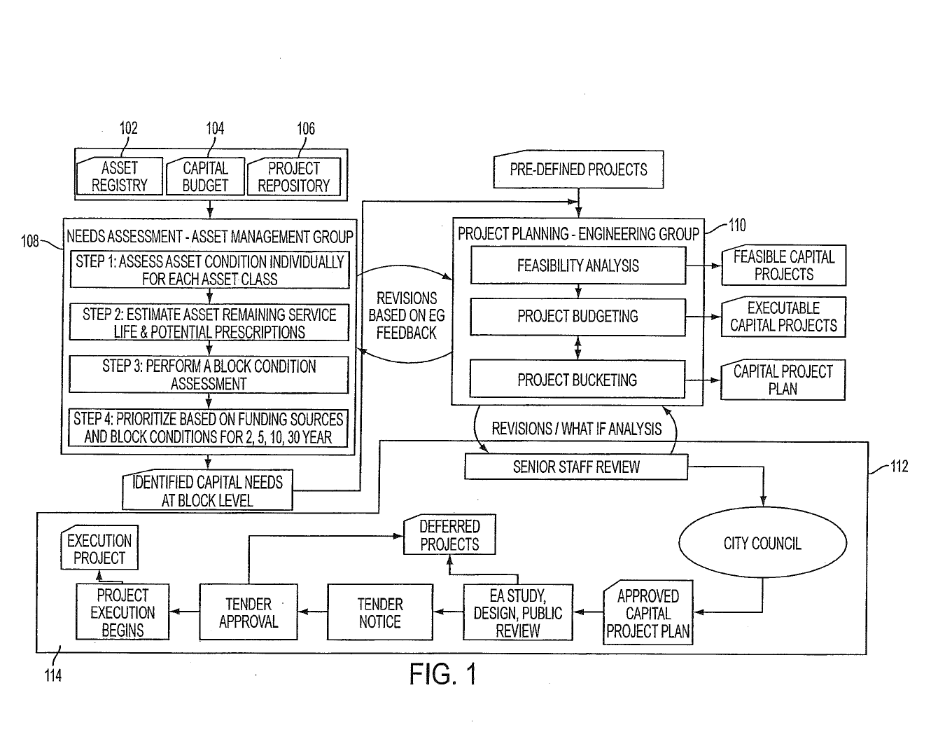

Turning now to FIG. 1, a process for capital planning is generally shown in accordance with an embodiment. As shown in FIG. 1, the process starts by analyzing information from three systems: enterprise asset management system 102, capital budget repository 104, and project repository 106. The enterprise asset management system 102 provides detailed information about the current state of the assets. This system forms the basis for assessing the “as-is” condition of the assets and is used to define the “to-be” state of the assets. The capital budget repository 104 provides the funding outlook and the project repository 106 provides information on the backlog of projects. The combination of all three systems forms the basis of the capital planning process.

As shown in FIG. 1, information from the enterprise asset management system 102, capital budget repository 104, and project repository 106 may be fed into a needs assessment process 108. Needs assessment may be performed by asset management group. In an embodiment, such as that shown in FIG. 1, the needs assessment process 108 is a four step process that includes analyzing the current condition of the assets. By analyzing the age, failure and maintenance history, this step allows an analytics driven approach to asset condition analysis. The second step of the needs assessment process 108 shown in FIG. 1, is estimating the remaining service life and potential prescriptions. As used herein, the term “remaining service life” of an asset refers to an estimate of how many more years the asset will continue to provide service based on its current state and the deterioration it is likely to undergo from this current state. In an embodiment, age is only used in the cases where there is no other information available for the asset. To compute the remaining service life of an asset, statistical and data mining algorithms may be used to analyze the impact of failures and maintenance history. Using the remaining service life, subject matter experts (SMEs) may identify and define prescriptions for the assets.

These first two steps of the needs assessment process 108 may be performed individually for each asset class. As used herein, the term “asset class” refers to a group of assets of similar type (e.g. roads, pipes, etc.). The performance of these steps results in identification of remaining service life and prescription options for each asset. Step three of the needs assessment process 108 as shown in FIG. 1, brings together prescription options across multiple asset classes (road, water, and storm and sewer) to identify block level asset needs (e.g., if the road needs a full depth reconstruction and the water pipe needs replacement as well as sanitary work, it identifies and categorizes these as candidates for full replacement). Step four of the needs assessment process 108 shown in FIG. 1, includes prioritizing projects based on funding sources available for each of the asset classes. This may be performed by taking into account expected costs of the projects and budget outlays for the future. This step results in a first cut of capital planning candidates.

As shown in FIG. 1, the planning process 110 begins when the capital project candidate list is communicated to the engineering group. The embodiment of the planning process 110 shown in FIG. 1 includes a feasibility analysis, project budgeting, and project bucketing. The feasibility analysis may result in identifying the precise cost of executing the project and its feasibility. Some projects may get deferred as part of this process, while for other projects the cost gets redefined. The subset of projects coming out of this step are fed into project budgeting and project bucketing which may be run multiple times before the final set of candidate projects emerge. Project budgeting allows the identification of the right project for the funding sources. Project budgeting may take into account complex business rules such as, but not limited to: funding mapping with asset class, funding mapping with project type, funding mapping with driver type, and funding mapping with prescription type. Project bucketing may combine multiple projects due to spatial proximity and/or similarity in prescription type. Project bucketing may be useful to preventing a neighborhood from having to deal with multiple construction projects in a short time span.

Output from the planning process 110 includes a set of projects that are then input to a review process 112 where it is reviewed with the senior staff. There may be multiple revisions that occur before the projects are presented to the city council for their review. As shown in FIG. 1, the approved capital projects may then go through a design and public review process, which could result in projects being deferred. The next stage shown in FIG. 1 is to create tender notice, and once tendered, the construction is scheduled. As shown in FIG. 1, projects that don't get satisfactory bids may be deferred. Finally, an execution phase 114 is performed which includes executing and completing the scheduled projects.

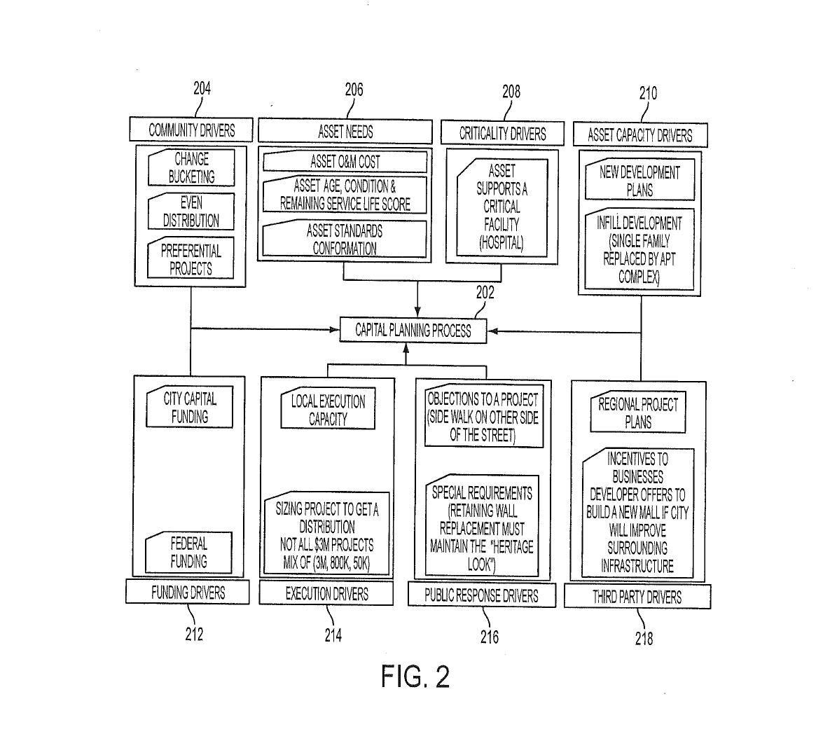

Referring now to FIG. 2, possible business drivers of a capital planning process 202 are depicted in accordance with an embodiment. As shown in FIG. 2, the business drivers are categorized into groups based on associated business imperatives. Community drivers 204 are focused on meeting the needs of the community. Community drivers 204 may include: minimizing the impact to the community (e.g., if one street is being repaved, it may be of value to repave the next street so that the neighborhood does need to undergo construction in two consecutive years), distributing capital projects evenly across all wards in a city to enable each community in a city to undergo improvement, considering selection of preferential projects deemed important (even if not financially compelling). Asset need drivers 206 include consideration of the assets themselves. An asset needing frequent and expensive operations and maintenance (O&M) costs may be a candidate for a capital replacement program. Alternatively, predictive and proactive maintenance of assets may be important to ensuring that expensive (O&M) costs can be reduced. As a result, asset age, current condition, and remaining service life computations may be used to identify assets having high risk of failures. Another aspect of asset need drivers 206 is the conformation to standards. Assets not conforming to standards may be important capital planning candidates.

Criticality drivers 208 as shown in FIG. 2 are used to define the level of dependence on the asset to support important or critical needs of the municipality. Assets with higher criticality may include, for example, road, water, storm, or sewer assets servicing hospitals, evacuation routes, schools, and community centers. Asset capacity drivers 210 take into account current and future needs for an asset. Over time the needs and/or service area may expand due to new development or redesign of the community. This may result in the reevaluation of the design criteria that was taken into account when the asset was new. Analyzing the capacity needs may help to uncover capital replacement opportunities.

Funding drivers 212 as shown in FIG. 2, take into account that different assets have different funding needs in order to ensure that the right funds are used for the right assets. Due to the combinatorial nature of funding mapping, capital projects may need to follow all of the funding driver constraints. Funding constraints may include, but are not limited to: asset type to funding mapping, treatment type to funding mapping, prescription option to funding mapping, and project driver to funding mapping. Asset type to funding mapping may define the type of asset and the funding type that can be used. Treatment type to funding mapping may define the treatment type (e.g., replace, rehabilitate) and the funding sources. Prescription options to funding mapping may define the specific prescription option (e.g., fifty millimeter overlay, pipe replacement) to the funding sources. Project driver to funding mapping may define the mapping of project driver (e.g., capacity, compliance, risk) to the funding sources.

Execution drivers 214, as shown in FIG. 2, take into account that capital projects may need to be executed by contractors and that the ability to execute the project in big part may be driven by local execution capacity. Thus, the capital projects may also need to be defined based on size constraints imposed by the execution capacity of contractors. Related to size is also the cost of the projects and, to ensure seamless execution, projects may need to be created across different cost buckets. Public response drivers 216 include the public's perspective on a capital project. Public response drivers 216 may manifest from historical, cultural, and heritage perspectives. Understanding and accounting for the public's response is an important driver to the capital planning process. Third party drivers 218 allow capital plans to take into account third party projects and/or needs. These may include items such as regional/federal government repaving a highway, a new funding source being defined, or a local developer initiating a major improvement. These opportunities may allow agencies to save money and to use the third party drivers to align capital projects.

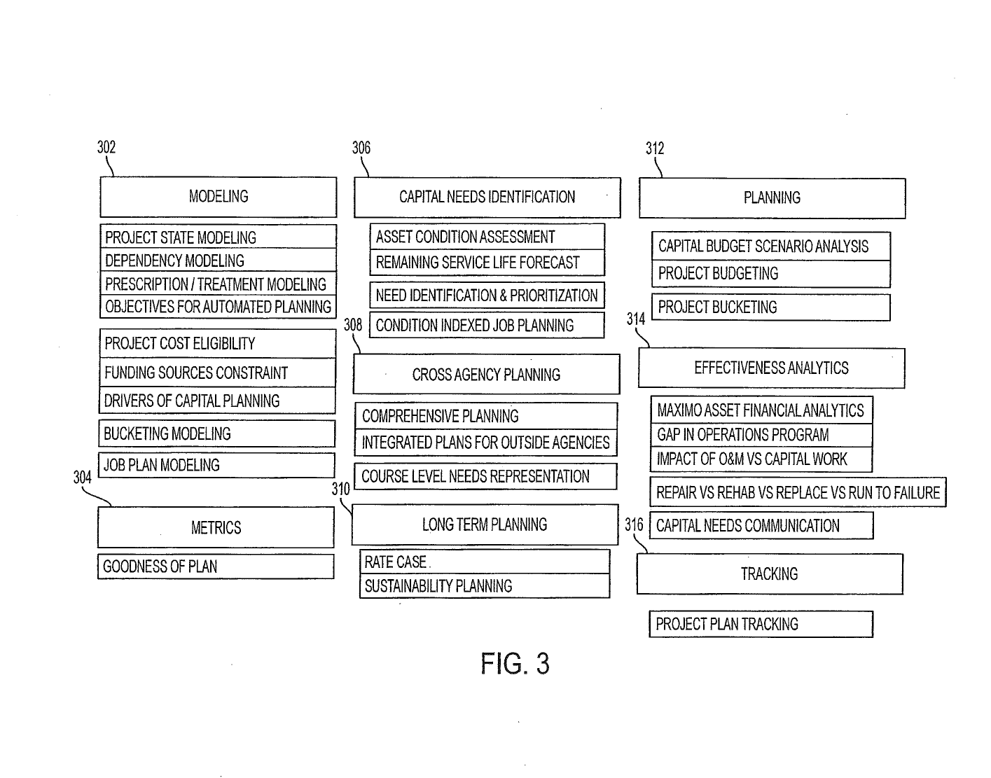

Referring now to FIG. 3, functions provided by an embodiment of the PALM tool are generally shown in accordance with embodiments. The functions shown in FIG. 3 include: modeling 302, metrics 304, capital needs identification 306, cross agency planning 308, long term planning 310, planning 312, effectiveness analytics 314, and tracking 316. Portions of the functions shown in FIG. 3 apply to different phases of asset management such as strategic decision, strategic analysis, execution, and performance evaluation. In an embodiment, with respect to modeling 302, project state modeling, dependency modeling, objectives for automated planning, and drivers of capital planning may be performed during all phases of asset lifecycle management; project cost eligibility and funding sources constraint may be performed as part of the strategic decision phase, prescription/treatment modeling during the strategic analysis phase; bucketing modeling during the execution phase; and job plan modeling during the performance evaluation phase. In an embodiment, with respect to metrics 304, goodness of plan may be performed as part of the performance evaluation phase.

Referring to FIG. 3, in an embodiment, with respect to capital needs identification 306, asset state condition assessment and remaining service life forecast may be performed as part of the strategic analysis phase; need identification and prioritization as part of the strategic decision phase; and condition indexed job planning as part of the performance evaluation phase. In an embodiment, with respect to cross agency planning 308, comprehensive planning and integrated plans for outside agencies may be performed as part of the strategic decision phase; and course level needs representation as part of the execution phase. In an embodiment, with respect to long term planning, rate case and sustainability analysis may be performed as part of the performance evaluation phase. In an embodiment, with respect to planning 312, capital budget scenario analysis and project budgeting may be performed as part of the strategic decision phase; and project bucketing as part of the execution phase. In an embodiment, with respect to effectiveness analytics 314, financial analytics, gap in operational program, and impact of O&M versus capital work may be performed as part of the strategic analysis phase; repair versus rehabilitation versus replace versus run to failure as part of the strategic decision phase; and capital needs communication as part of the execution phase. In an embodiment, with respect to tracking 316, project plan tracking may be performed as part of the execution phase.

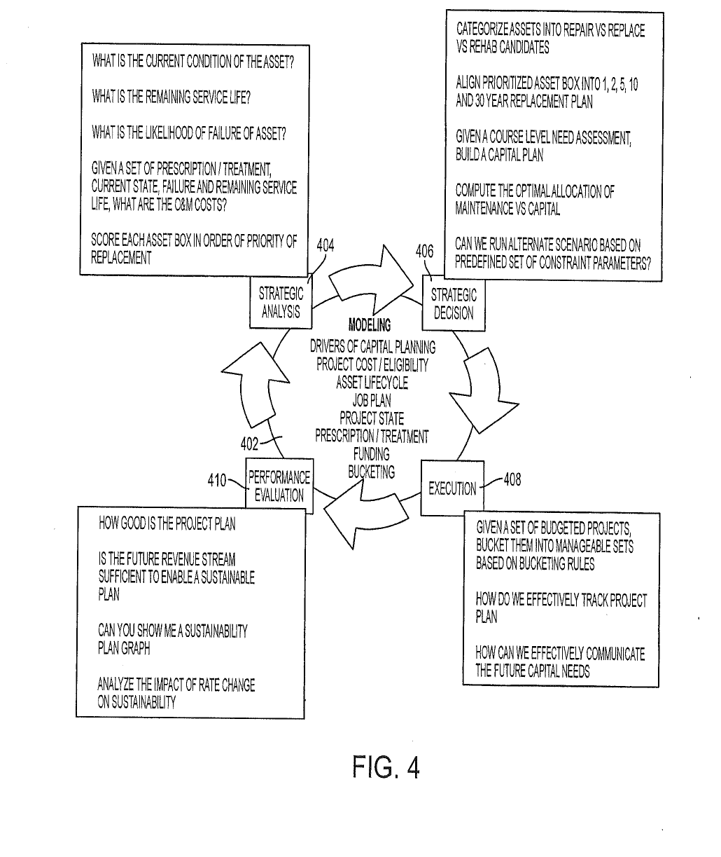

Turning now to FIG. 4, a block diagram that defines the four phases of asset lifecycle planning and key business questions answered by each phase is shown in accordance with an embodiment. As shown in FIG. 4, outcomes from each phase feed into the next phase of planning. The lifecycle starts with the strategic analysis phase 404, which may include performing analysis to better understand the current and future condition of assets, identifying assets needing replacement/rehabilitation, and aiding in prioritization of asset needs. The types of business questions asked during the strategic analysis phase 404 may include questions such as, but not limited to, those shown in FIG. 4: what is the current condition of the asset; what is the remaining service life of the asset; etc. The strategic decision phase 406 may allow the identification of a “next best action” given the analysis from previous phase (i.e., the strategic analysis phase 404). This strategic decision phase 406 helps identify and categorize project needs into repair vs. rehabilitation vs. replace vs. run to failure. The prescriptive nature of the strategic decision phase 406 allows decision makers to perform “what-if” analysis taking into account uncertainty. Long horizon planning is supported by embodiments to provide sustainability and rate case analysis for the next ten, thirty, and one-hundred years. The types of business questions asked during the strategic decision phase 406 may include questions such as, but not limited to, those shown in FIG. 4: categorize assets into repair vs. replace vs. rehabilitation candidates; given a course level need assessment, build a capital plan, etc.

The execution phase 408 shown in FIG. 4 receives input from the strategic decision phase 406 and may allow effective execution by analyzing cross agency needs to identify projects that can fix multiple assets as part of an integrated project (e.g., fix road and pipes at the same time in a block of road). Additionally, this phase may identify and bucket projects that bring together, for example, multiple blocks of a road into one project to improve the effectiveness and help bring down the overall cost. The types of business questions asked during the execution phase 408 may include questions such as, but not limited to, those shown in FIG. 4: how do we effectively track project plan; how can we effectively communicate the future capital needs; etc. Finally, the performance evaluation phase 410 assesses the effectiveness of the plans and it includes running “what-if” scenarios and evaluating alternatives to ensure robustness of the solution. This allows quantification of the impact of change on the final metric being measured. For example, for performing a sustainability analysis for thirty years, one scenario would be to increase the budget linearly over time, and another scenario would be front-loading or infusing a temporary bump in the funding for first five to ten years. Both the scenarios would have a different impact on the backlog and would provide insights into the right strategy to be used for capital planning. The types of business questions asked during the performance evaluation phase 410 may include questions such as, but not limited to, those shown in FIG. 4: how good is the project plan; analyze the impact of rate change on sustainability; etc.

As shown in FIG. 4, all of the asset lifecycle planning phases use a common model 402 stored, for example, in a PALM database or other repository. In an embodiment, output from each phase is stored in the model 402 and the input to each phase is retrieved from the model 402. The embodiment of the model shown in FIG. 4 includes drivers of capital planning, project cost/eligibility, asset lifecycle, job plan, project state, prescription/treatment, funding, and bucketing. The common data model enables descriptive, predictive and prescriptive analytics to be performed on the data that evolves from one use case to another. For example, the infrastructure profile may feed data to predictive performance analysis for road, water, storm and sewer. The resulting output of predictive analytics (e.g., mean residual life of assets, failure probability) may feed into the needs assessment model. The needs assessment model may take in the input from predictive analytics to identify the current and future health of assets, associate prescription options with assets having bad health, and provide insight into the future sustainability of the assets. The outputs from needs assessment may be combined in project identification where a spatiotemporal analysis may be done to identify co-located projects. In addition, the optimal co-located projects may be pulled in Investment planning to apply financial, resource, time and budget constraints to find the executable set of projects

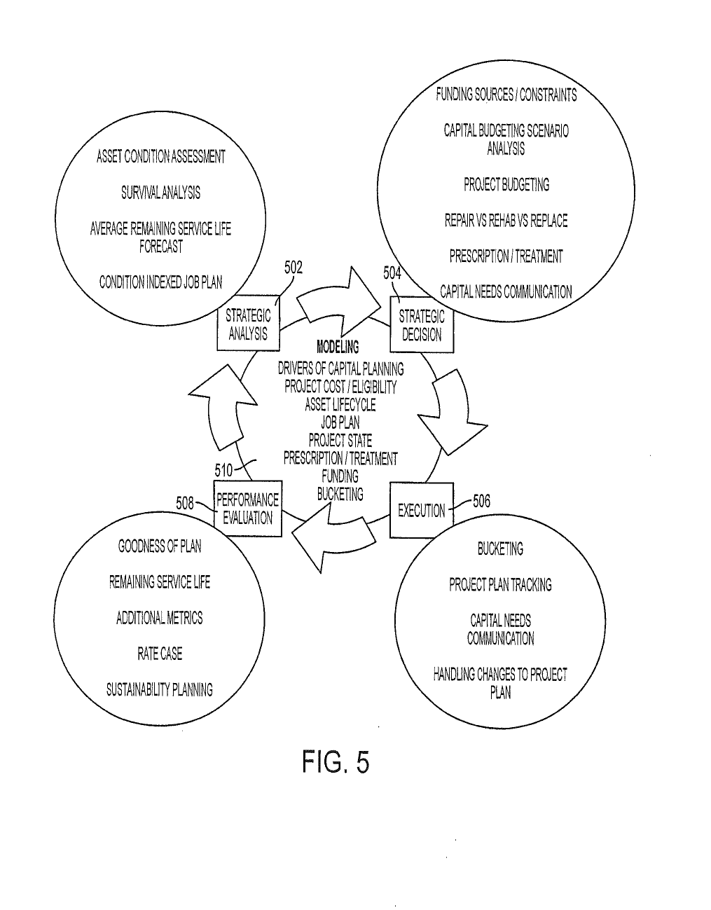

Turning now to FIG. 5, a block diagram that maps four phases of asset lifecycle planning to functions is generally shown in accordance with an embodiment. The strategic analysis phase 502 may be performed using predictive analytics. Identifying the current condition of the assets and predicting the remaining service life may provide a strategic view on asset performance. The types of functions performed during the strategic analysis phase 502 may include functions such as, but not limited to, those shown in FIG. 5: asset condition assessment; survival analysis; etc. The types of functions performed during the strategic decision phase 504 may include functions such as, but not limited to, those shown in FIG. 5: identifying funding sources/constraints; project budgeting; etc. The types of functions performed during the execution phase 506 may include functions such as, but not limited to, those shown in FIG. 5: bucketing; project plan tracking; etc. The types of functions performed during the performance evaluation phase 508 may include functions such as, but not limited to, those shown in FIG. 5: evaluating the goodness of the plan; determining remaining service life; etc. As shown in FIG. 5, all of the asset lifecycle planning phases use a common model 510 stored, for example, in a PALM database or other repository.

An embodiment, implements a step wise support methodology for use in making effective decisions that identifies asset health and prescribes treatment options for assets having bad health. This includes identifying the industry standard drivers and factors, building treatment options most common for asset classes, and providing the ability to customize the treatment options. Embodiments also provide a dashboard capability for subject matter experts (SMEs) to understand and interpret the decisions.

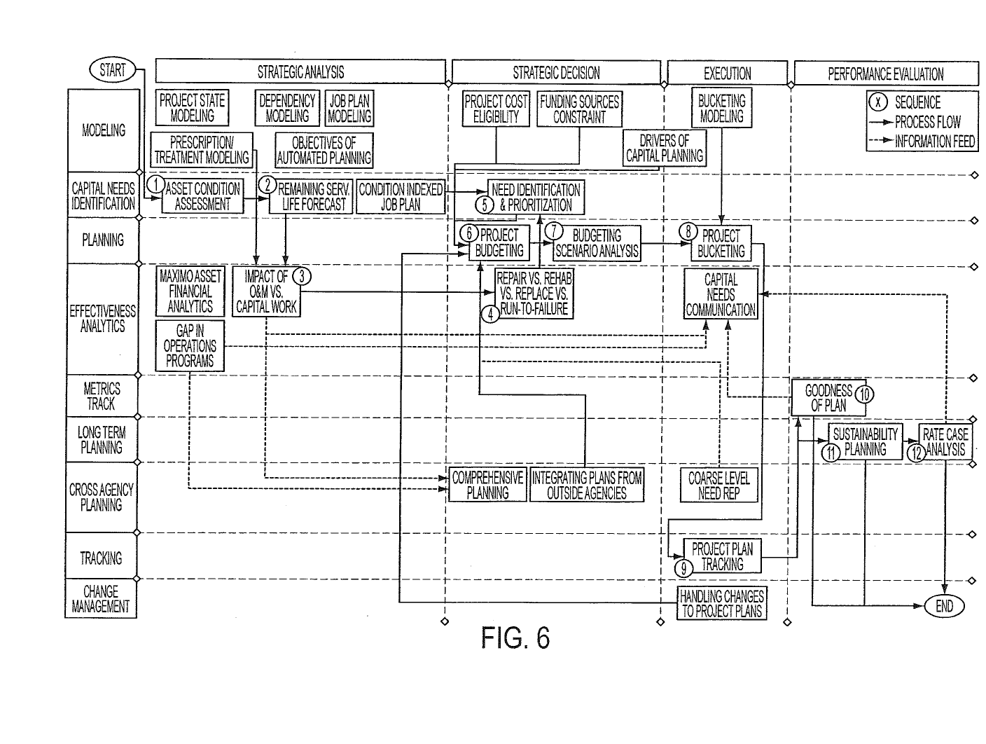

Turning now to FIG. 6, an end-to-end process flow for capital planning is generally shown in accordance with an embodiment. The content of FIG. 6 is similar to FIG. 3, however, FIG. 6 presents the information in a different format, shows dependencies between functions, and categorizes each of the functions in terms of the lifecycle phase where it occurs.

Embodiments described herein include a comprehensive methodology and framework to allow multiple city agencies to analyze, identify and prioritize the investment in a city infrastructure to allow for planned and sustainable performance management of city assets. The methodology and framework are implemented, for example, by a PALM tool. Embodiments of the framework combine the best practices across agencies, integrate multiple standalone systems, and provide an analytics driven dashboard experience to enable better decision making by multiple agencies in the city. Embodiments aid in generating a sustainable plan by providing detailed information on cost vs. benefit, best in class policies/procedures and detailed quantitative and qualitative reporting.

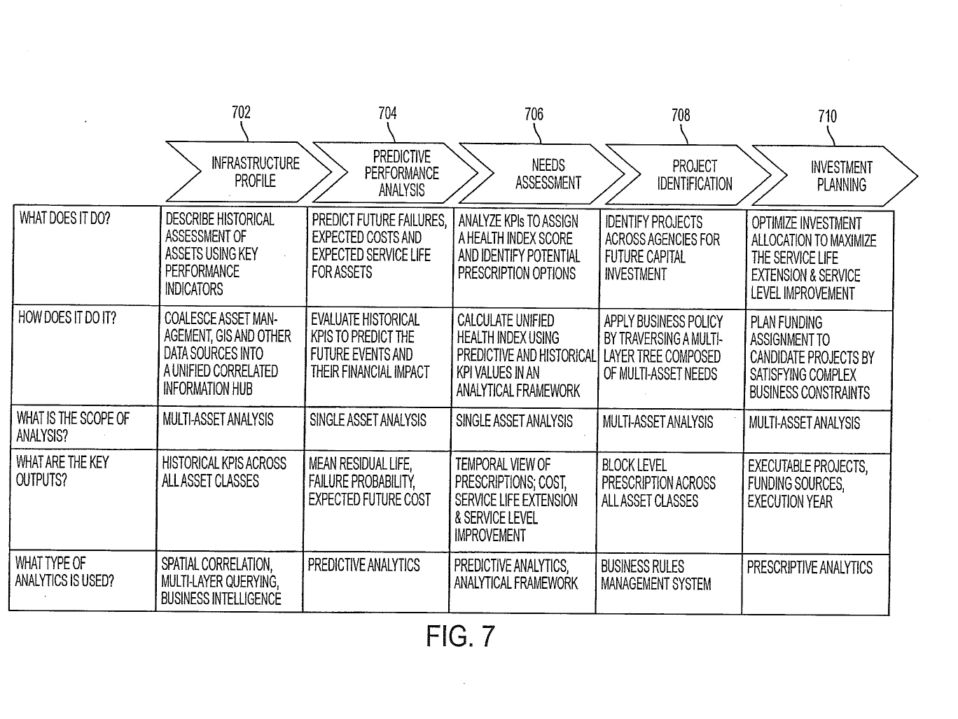

Turning now to FIG. 7, a methodology that includes five modules that may be used for planning by a utility customer is generally shown in accordance with an embodiment. The methodology shown in FIG. 7 includes infrastructure profile module 702, predictive performance analysis module 704, needs assessment module 706, project identification module 708, and investment planning module 710. The methodology starts at infrastructure profile module 702 by assessing the historical information from asset management systems. An embodiment of the methodology connects into, and pulls historical information from asset management systems, financial metric systems, and spatial attribute systems. Infrastructure profile module 702 brings together and connects the information from city facilities and public works to provide one unified view of current and past performance of city infrastructure. This may allow an integrated view into city infrastructures. The next module in the methodology shown in FIG. 7 is predictive performance analysis module 704 which uses historical information to apply predictive analytics to identify future conditions/failures. The predictive analytics and asset performance indicators (e.g., key performance indicators or “KPIs”) help identify the short and long term needs of the assets. The methodology shown in FIG. 7 supports analyzing and identifying the right policies and business rules to improve the performance of the assets. It also performs a long term evaluation of the policies to ensure sustainability.

The next modules in the methodology shown in FIG. 7 are needs assessment module 706 and project identification module 708 where the needs assessments for each asset class (i.e. road, water, buildings, etc.) are combined together using cross agency rules (e.g., if pavement quality index or “PQI” of road is less than four and the water pipe is bad, then do a full reconstruct of both in the same year). This ensures that the investment plans take into account cross-agency/cross-asset needs to minimize fixing an asset twice or more. As part of investment planning module 710, the multi-agency projects may be fed into an investment planning system to identify the right projects to be done at the right time using the right funding source. The end-to-end approach implemented by embodiments ensures a sustainable investment strategy that is based on applying descriptive, predictive and prescriptive analytics to the data available in the enterprise assessment, financial and government information systems (GIS).

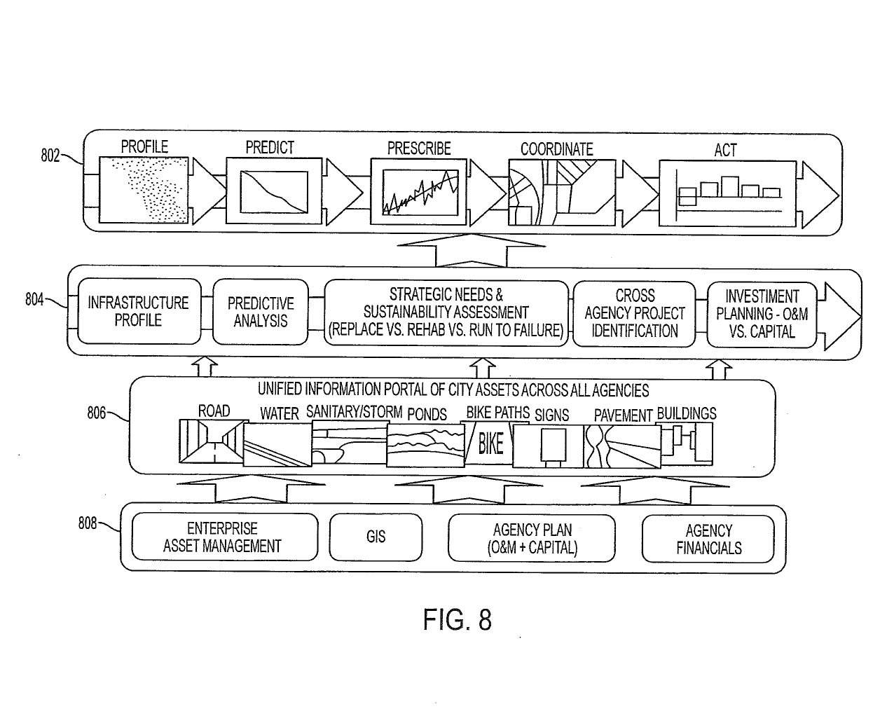

Turning now to FIG. 8, a system for performing lifecycle management of city assets is generally shown in accordance with an embodiment. As shown in the embodiment in FIG. 8, information is sourced from a variety of systems 808 to provide a planning repository 806 that includes a uniform view of city assets across all agencies. Road department KPIs may include, average annual daily traffic, number of potholes per one-hundred meters, and type of road (e.g., highway, inner road). For a water department KPIs may include size of water pipe, number of customers serviced, and past supply outages. Additional departments may include storm and sewer systems that have their own KPIs. Giving the road department visibility into not only their infrastructure but into other infrastructures, such as the water infrastructure, allows cross agency planning to be performed. A variety of planning outputs 802 are shown in FIG. 8 including profiles, predictions, prescriptions, coordination of projects, and actual results.

The modules 804 perform a planning methodology, such as that described in reference to FIG. 7, and they may use data from the planning repository 806. Embodiments provide a flexible data model (stored, for example, in the planning repository 806), a flexible architecture, SQL queries and analytics to allow multiple types of assets and corresponding properties to be analyzed. An embodiment of the planning repository 806 includes data related to road assets such as, but not limited to: age, material, construction year, length, average annual daily traffic, width, road class, last maintenance date, replacement cost, truck route, and school bus route. An embodiment of the planning repository 806 includes data related to water assets such as, but not limited to: age, material, construction year, road class above pipe, diameter, condition rating, replacement cost, water quality index, service connections, last failure date, last replacement date, and total number of failures. An embodiment of the planning repository 806 includes data related to storm assets such as, but not limited to: age, material, construction year, road class above pipe, diameter, structural score, inflow and infiltration (INI) score, service to critical facility, service connections, last failure date, last replacement date, total number of failures, and operational score. An embodiment of the planning repository 806 includes data related to sewer assets such as, but not limited to age, material, construction year, road class above pipe, diameter, structural score, INI score, service to critical facility, service connections, last failure date, last replacement date, total number of failures, and operational score. Data about additional assets such as, but not limited to parking lots, storm ponds, bridges, service mains, and service connections may also be stored in the planning repository.

In an embodiment of the planning repository 806, all spatial data is stored in four database tables: a geometry point table (includes shape identifier and shape point fields), a geometry polygon table (includes shape identifier and shape polygon fields), a geometry line table (includes shape identifier and shape line fields), and an asset mapping table (includes shape identifier and asset identifier fields). These tables allow embodiments to store data related assets such as, but not limited to roads, water, storm, sewer, street lights, storm ponds and parking lots. Using a data model with these tables, no additional design or development effort is required to add additional shapes.

In an embodiment of the planning repository 806, asset property tables are used, including an asset class table (includes asset class identifier and asset class name fields), an asset identifier table (includes asset class identifier and asset identifier fields), a property table (includes property identifier and property name fields), and an asset cross property table (includes asset identifier, property identifier, and property value fields). This table structure has no hardcoding on the type of asset that it can store. Any property of an asset may be entered. For example, for a road asset, stored properties may include, but are not limited to average annual daily traffic, age, material, road class, PQI index, length, type, construction year, replacement year, maintenance cost, and replacement cost. For a water asset, stored properties may include, but are not limited to number of households supported, age, material, road class above pipe, water quality index, length, and inspection rating.

Referring back to FIG. 7, an embodiment of the infrastructure profile module 702 may input asset class data, asset property feature data, asset factor data, asset identifiers mapped to asset properties and asset property data. An embodiment of the predictive performance analysis module 704 may output data failure by asset data, failure probability curve data, predictive factor data, factor impact data, factor significance data, and mean residual life data. Input to scoring validation in an embodiment of the needs assessment module 706 may include factor index data, execution scenario data, driver data, error information data, asset performance correlated to treatment data, asset correlated to driver data, driver correlated to factor data, degradation data, factor data, and treatment data. Output from the scoring validation may include validation data. Still referring back to FIG. 7, input to needs assessment scoring in an embodiment of the needs assessment module 706 may include execution parameter data, asset class data, driver data, degradation data, factor index data, asset correlated to treatment data, scenario data, asset performance correlated to treatment data, asset mapping data, asset factor data, asset correlated to driver data, asset identifier data, factor data, driver correlated to factor data, asset class filter data, and treatment filter data. Output from needs assessment scoring in an embodiment may include asset score data, asset class score data, asset driver score data, asset prescription data, and asset factor score data.

Still referring back to FIG. 7, input to sustainability analysis in an embodiment of the needs assessment module may include asset factor data, asset prescription data, budget treatment allocation data, execution parameters data, factor data, budget percentage parameters data, execution objective data, sustainability data, and budget parameters data. Output may include execution objective data, asset prescriptions selected data, and asset prescription data. In an embodiment, the asset prescription data is output with data that describes asset prescriptions that remain. Input to the project identification module 708 may include yearly budget data, asset factor data, planning horizon data, factor identifier age data, asset score data, identified projects data, treatment data, asset correlated with treatment data, project type data, asset mapping data, project type class data, and budget percentage by project type data. Output may include project data, groups data, and project asset data.

Still referring back to FIG. 7, input to the investment planning module 710 may include funding correlated with treatment data, execution parameters data, renewal correlated with asset class data, groups data, project type class data, asset class data, budgeted projects data, funding source amount data, project asset data, funding correlated with asset class data, project data, funding correlated with location driver data, and treatment data. Outputs may include service life summary data, service life details data, funding detailed allocation data, and funding utilization data.

All or portion of the data described above may be stored in the planning repository 806 as individual or consolidated tables or other data stores. Data may be stored in any manner or format (e.g., database tables, non-database managed sequential files) that supports the data accesses described herein.

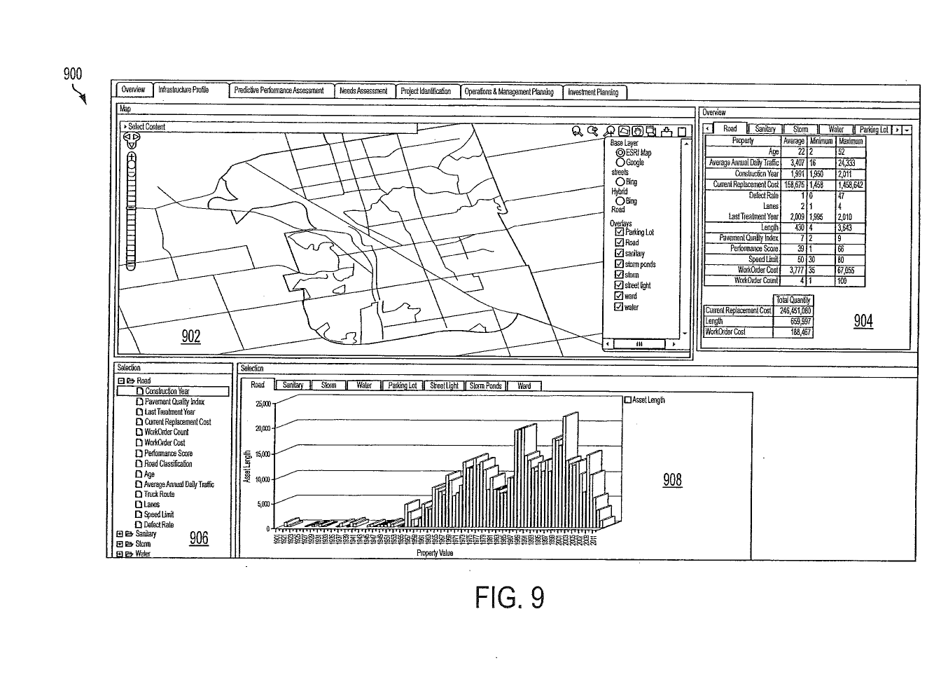

Turning now to FIG. 9, a user interface (UI) 900 of an infrastructure profiling module is generally shown in accordance with an embodiment. The infrastructure profiling module may bring cross-agency city asset data into one information dashboard for performing spatially queries and analysis of the city infrastructure performance. For example, given a city spatial bound, infrastructure profile reports could be used for: getting summary statistics of the infrastructure, such as average construction year, length, pavement quality, number of complaints, dollars spent on maintenance; answering strategic financial questions, such as “Which assets are most expensive to maintain?” or “Where have I spent my O&M money?” and so on; and quickly responding to questions from executives/council members, such as “Is it true that we have not done much capital investment in a specific ward?”.

Different views of the data are shown in the UI 900 of FIG. 9 including: a map view 902, a strategy view 904, a left tree view 906, and an operational view 908. An embodiment of the map view 902 shows the geographical representation of the assets with each asset class represented as a color coded layer on the map. An embodiment of the strategy view 904 shows the average, minimum and maximum values for the key asset performance factors, allowing users to understand the asset class level aggregate performance values. The strategy view 904 may generate a tab for each asset class selected. An embodiment of the left tree view 906 contains the navigation menu to view the corresponding charts in the operational view 908.

Embodiments of the operation view 908 contain histogram charts, showing the detailed distribution of asset performance factors per asset length and/or quantity. After expanding an asset class from the tree menu and selecting a performance factor, the operational view 908 then shows the corresponding chart having detailed distribution of the performance factor. Example histogram charts include a chart showing the construction year distribution for the road asset class, a chart showing the pavement quality index distribution for the road asset class, a chart showing the service connection count distribution for the water asset class, a chart showing the diameter distribution for the storm asset class, and a chart showing the construction year distribution for the sanitary asset class.

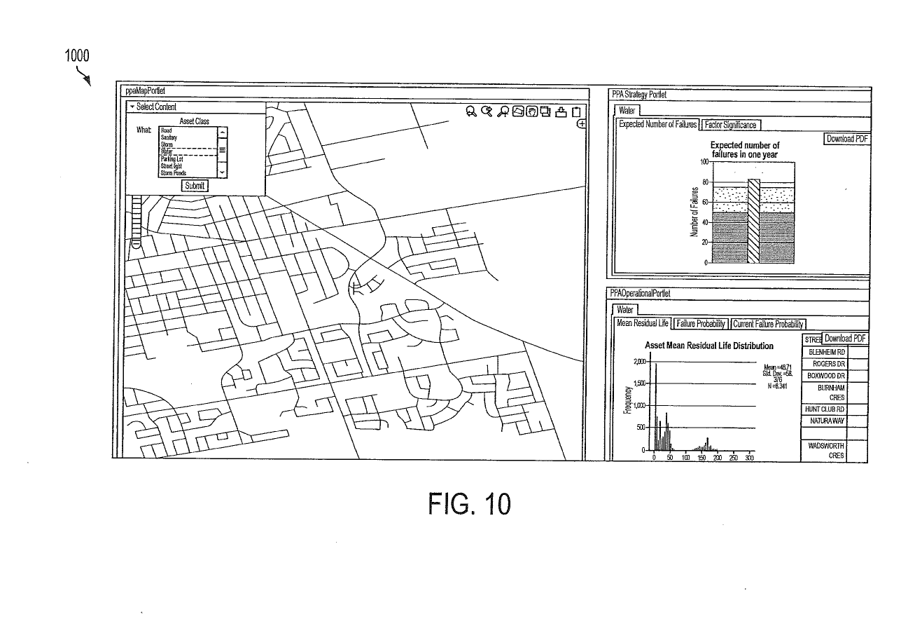

Turning now to FIG. 10, a user interface (UI) 1000 of a predictive performance asset module is generally shown in accordance with an embodiment. The predictive performance asset module may provide current and future condition based assessment of the assets. In an embodiment, the predictive algorithms take in data from a GIS and asset management system to give a true indicator of a remaining service life of assets. Predictive models may use one or more of association, clustering, classification and forecasting to unearth complex patterns of asset characteristics (physical) and circumstances (operational). Spatial analytics may also be used to unearth correlation among assets. In addition, the UI 1000 may include an analytics dashboard to provide the end user with the ability to quickly analyze and interpret the results

In an embodiment, the predictive models for road, water, storm and sewer assets involve using inspection, maintenance and asset history to forecast the failure risk over time, mean residual life of assets, and availability of assets over time. An embodiment applies spatial correlation analysis, survival and renewal analysis and degradation models to generate the outputs. In an embodiment, a survival probability “hᵢ(t)” is calculated as shown below using a baseline h₀(t) and applying both time varying factors and time invariant factors shown in the equation below.

hᵢ(t)=h₀(t)e^{β}^{₀}^{+β}^{₁}^{x}^{₁}^{(t)+ . . . +β}^{ₚ}^{x}^{ₚ}^{(t)+α}^{₁}^{x}^{ₚ₊₁}^{+ . . . +α}^{ₘ}^{x}^{ₚ₊ₘ}.

In an embodiment, the survival function itself is represented as:

Sᵢ(t)=exp[∫₀^{τ}hᵢ(t)dt]

Further the mean residual life of the asset may be calculated as:

$${m}_{i} ( t ) = E [ x - t \vert x > t ] = \frac{1}{{S}_{i} ( t )} {\int }_{t}^{∞} {S}_{i} ( u ) d u$$

In an embodiment, a formalized method of analytics based assessment includes performing rick factor modeling (e.g., domain insight and data extraction). Risk factors for a water asset, for example, may be categorized as physical indicators (e.g., material, diameter, age, length), load (e.g., buried depth, average water pressure, maximum water pressure, impact strength), weather (e.g., temperature, precipitation), historical breakage (e.g., incident data and location, incident type), and corrosion (e.g., water quality, soil condition, weather). This historical fault data and pipe network data may be input to data preprocessing to ensure that the data is qualified for statistics. Data qualification implies the validation and preparation to remove null values, fill up missing values with averages, rule base property application, aggregation or truly qualify unknown values, etc. Next, feature selection may be performed (e.g., principle component analysis to simplify the model) to determine key factors. Feature selection involves identify the strength of the predictive factors. This involves among other things doing correlation analysis among factors to compute the correlation values and performing association analysis.

Clustering may then be performed based on the key factors to improve the precision of forecasting by dividing the breakage into several segments. In an embodiment, each segment has a different model/parameter set for risk forecasting. For example, the roads may be clustered by types of roads, i.e. highways, laneways, streets. They may then be sub-clustered by age i.e. 0-10 years, 10-25 years and 20-45 years and 45-100 years. Having clustering provides a more fine grained computation of the predictive factors. Output from the clustering may include, for example, when the assets are water assets, burst/leakage scenario segments, when the assets are road assets, PQI deterioration to below four.

This output from the clustering may be input to model fitting where a precise forecasting model for each breakage scenario is generated. Based on the model fitting, a prediction model, in this example, a burst/leakage prediction model is then generated and may be used to check the risk level of each pipe. The prediction model applies multiple types of regression to identify the best fit of the underlying functions. The core outputs provide the hazard rates, the coefficients for time variant and time invariant values. Significant covariates may have values for diameter of pipes, length of pipes, PVC, cast iron, number of breaks etc. In an embodiment, each covariate may be output as a two dimensional graph with a hazard rate on the y-axis and a presumed pipe age on the x-axis. Data points for incidents types that may include, but are not limited to, interference by others, pipe deterioration, tree root incursions, corrosion, connection hose, other, and no observed break may be plotted on the graph. The covariates are then used to compute the mean residual life of assets.

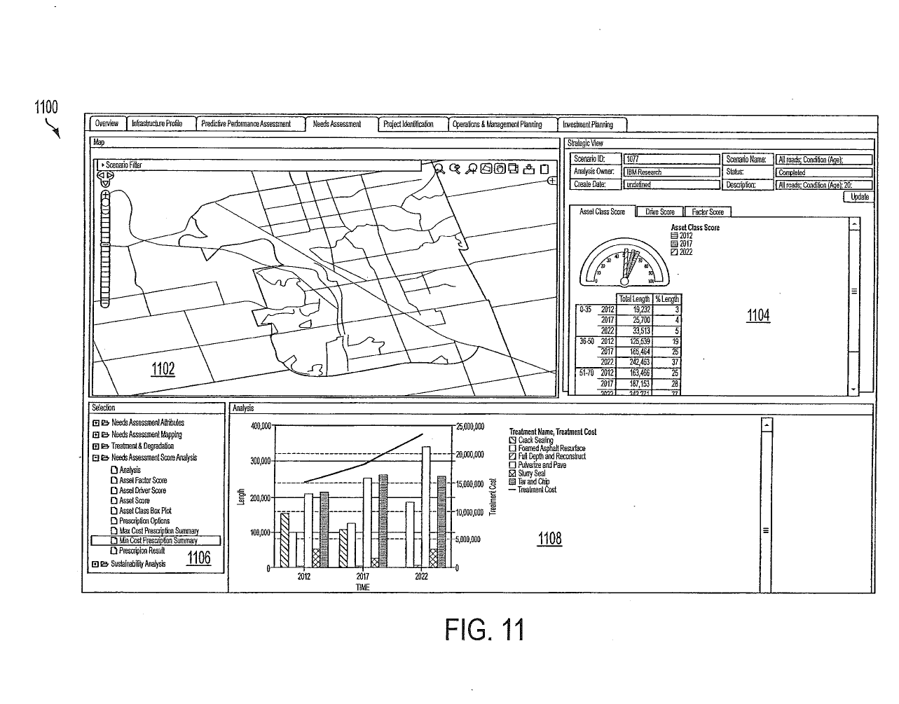

Turning now to FIG. 11, a user interface (UI) 1100 of a needs assessment module is generally shown in accordance with an embodiment. The needs assessment module is a framework that allows each asset class (road, water, storm, sewer, etc.) to be analyzed and scored (e.g., on a scale of 0 to 100) by a SME. The scoring methodology may take into account SME defined business drivers and KPIs. The scores may also be mapped to a set of prescription options. As a result, the SME may be able to determine the right treatment for each asset. An embodiment of the asset health module includes three major components: asset health computation, prescription (treatment) identification, and sustainability analysis.

Different views of the data are shown in the UI 1100 of FIG. 11 including: a map view 1102, a compute view 1104, a left menu tree view 1106, and a content layout view 1108. An embodiment of the map view 1102 provides a geographical representation of asset scores/health index values with color codes on the map ranging from green (assets in good health) to red (assets in bad health). An embodiment of the compute view 1104 provides an overall asset class health assessment. It may also provide the scenario details such as: scenario identifier (unique identifier for the scenario), scenario name (name given by user to the scenario), analysis owner (name of the person performing the analysis), status (open vs. completed based on the state), create date (date the scenario was first created), and description (detailed overview of the scenario). Different tabs may be selected in the compute view 1104 of the UI 1100 for asset class score, driver score, and factor score.

Selection of the asset class score, as shown in FIG. 11, may result in display of overall asset class score using an odometer chart and its distribution into multiple ranges (percentage of assets having scores in range 0-35, 36-50, 51-75, and 76-100) depicted by a table. Selection of the driver score tab may result in a driver level aggregate asset score being shown by an odometer chart and its distribution into multiple ranges (percentage of asset having scores in range 0-35, 36-50, 51-75, and 76-100) depicted by a table. Similar to the asset class score, driver score is calculated for each analysis year as a length-weighted average of the individual asset scores for the given driver. Each driver may be represented by a separate odometer chart. Selection of the factor score tab may result in the average scores by factors being shown by a line chart (e.g., with a y-axis representing percentage of length and an x-axis representing year). This data may be the most granular view provided by the needs assessment module.

An embodiment of the left tree menu view 1106 allows a step wise process to perform asset health computation, prescription identification, and sustainability analysis. As shown in FIG. 11, the left navigation menu has four high level groups: needs assessment mapping, treatment and degradation, needs assessment score analysis, and sustainability analysis.

The selection of an add new asset filter option from the needs assessment option in the left tree menu view 1106 allows adding a new asset filter and corresponding values on which the filter should be applied. This may be an inclusion filter which means that each row in the asset filter table is applied as an “AND” condition. For example, if a user is performing a road analysis and wants to analyze only “local” roads that are more than 25 years old, then one row would be added for each for the two conditions. In an embodiment, for each condition, the user selects the asset factor, index type (range, string or integer), and corresponding values. Another option from the needs assessment option is to delete an asset class filter. The selection of asset driver from the needs assessment option allows the user to define key business drivers for the analysis. For an asset, the user can select or insert the business driver. Each asset driver is associated with a score that also defines the relative importance of the driver. The sum total of all scores should add up to one-hundred.

The selection of a driver factor option from the needs assessment option in the left tree menu view 1106 allows definition of the asset factors for each of the drivers. The sum of the factor scores for each driver should add up to one-hundred. A user can select the same factor across two different drivers and a default value may be used for assets that do not have values.

The selection of a factor index option from the needs assessment option in the left tree menu view 1106 allows, for each driver-factor combination, the user to define the detailed weight for each value of the factor. For example, if the user has selected a factor called road classification, then for each factor value (highway, local, ramp, etc.) the user can associated a weight.

In an embodiment, adding a factor index is performed by selecting a driver from a list of drivers, then selecting a factor. Both the driver and the factor dropdown screens may only show pre-defined values. Next, the user selects the data type/index type. The data types may be range, string or integer. Next, the user may select/enter values corresponding to the factor value and associate the index value for each factor index. The factor index value is the health score an asset should be assigned. For example, if the user is adding age as a factor and assigning an index for an age range from year sixty to seventy, and the interpretation of that range is that the health index is bad/low then the user will assign a low score to that factor index. The asset health score may range from a low of zero to a high of one-hundred. Factor indexes may also be deleted and/or copied.

In an embodiment, the selection of treatment and degradation from the left tree menu view 1106 is used, together with the asset health scores, to identify the prescriptions for the assets in need. Treatment detail data may be used to define a valid set of treatments applicable to the current scenario. Alternatively, for each treatment the user defines the measurement unit, the unit cost, service life extension in years, and service level improvement. Treatment applicability data may be used to define the range of a driver-level asset health score which requires specific treatment options (e.g., if condition score is between zero and thirty, then a replacement treatment option is applicable). Degradation data may be used to define the degradation of time dependent factors. The asset factors that degrade over time can be defined here, and the user can define the degradation as a discrete function. In addition, the user can define them as linear, convex, concave or step functions, with each row in a table representing a point of change for the function. A treatment exclusion filter may be used to define the exclusion criteria for specific treatments, such as not allowing rehabilitation treatments for very old assets. Filters in the same “filter group” may be processed by getting combined with an “AND” condition, and filters in different “filter groups” may be processed by an “OR” condition.

In an embodiment, the selection of needs assessment score analysis from the left tree menu view 1106 is used to run the needs assessment analysis. The health score and prescription output reports are also contained in this group. A validation options allows checking of all input data for any errors, inconsistencies or gaps that may result in the model miscalculating the asset health scores. The validation option may perform a rigorous check of the input data to ensure that all data is correct for analysis. Errors and warnings may be displayed via the UI 1100. Input parameters for the assessment analysis may be specified and they may include: an analysis duration (time horizon of the analysis to calculate asset health scores, can range from one to one-hundred); an analysis interval (interval at which the asset health needs to be computed, this can be as granular as one year to five years, any interval value less than the duration can be defined); and analysis start year (analysis start time to calculate asset health scores).

In an embodiment, the selection of analysis from the needs assessment score analysis option in left tree menu view 1106 causes a health index calculation to be performed.

In an embodiment, the selection of asset factor score from the needs assessment score analysis option in left tree menu view 1106 causes a detailed health score for each asset and each factor defined by the user to be generated. In an embodiment, a report is generated, and presented in the content layout view 1108 of the UI 1100, that includes, for each asset: an asset identifier, a location description, a street name, a driver name, a factor name, a factor score, a weighted factor score, a factor value and a time. In addition, the score may be computed for the complete analysis duration at each analysis interval.

In an embodiment, the selection of asset factor driver score from the needs assessment score analysis option in left tree menu view 1106 causes a driver level score for each asset to be generated. In an embodiment, the driver scores are the sum-product of asset factor scores and their weights (e.g, driver score=sum of factors (factor weight*factor score)). In an embodiment, a report/table is generated that provides a breakdown of scores at the driver level. In an embodiment the report is presented in the content layout view 1108 of the UI 1100, and includes, for each asset: an asset identifier, a location description, a street name, a driver name, a driver score, a weight, a weight driver score, and a time.

In an embodiment, the selection of asset score from the needs assessment score analysis option in left tree menu view 1106 causes a report to be generated, and presented in the content layout view 1108 of the UI 1100, that includes, for each asset: an asset identifier, a location description, a street name, an asset score, and a time. In an embodiment, the asset score provides the overall score for each asset. It rolls up the driver score based on the weights assigned to each driver (e.g., asset score=sum of drivers (driver weight*driver score)).

In an embodiment, the selection of prescription options from the needs assessment score analysis option in left tree menu view 1106 causes a report to be generated, and presented in the content layout view 1108 of the UI 1100, that includes, for each asset: an asset identifier, a street name, a length, a driver, a treatment, a time, a cost, a service life extension estimate, a service quality improvement estimate, and a service life summary estimate. In an embodiment, prescription options are listed out with the potential prescriptions/treatments assigned to each asset. Each asset may be assigned more than one prescription based on the treatment applicability. An embodiment computes at each analysis interval across the analysis time duration.

In an embodiment, the selection of maximum cost prescription summary from the needs assessment score analysis option in left tree menu view 1106 causes a chart to be generated, and presented in the content layout view 1108 of the UI 1100, that depicts a maximum cost by year when the most expensive prescription option for each asset is selected. An embodiment, of the chart may also show for an asset class, a high level view of the total cost by prescription type and by year, considering the most expensive prescription option for each asset has been selected.

In an embodiment, the selection of minimum cost prescription summary from the needs assessment score analysis option in left tree menu view 1106 causes a chart to be generated, and presented in the content layout view 1108 of the UI 1100, that depicts a cost by year when the least expensive prescription option for each asset is selected. An embodiment, of the chart may also show for an asset class, a high level view of the total cost by prescription type and by year, assuming that the least expensive prescription option for each asset has been selected.

In an embodiment, the selection of sustainability analysis from the left tree menu view 1106 is used to perform long term sustainability analysis. In an embodiment, asset health scores and prescription options are the main input for this section. Using this option, users may perform a sustainability analysis to identify a budget deficit and sustainability needs for long term planning. The user can analyze the future tax/funding base to identify and mitigate any funding gaps. This analysis allows two types of scenarios to be evaluated: given a multi-year funding/budget, what is the average age of assets, what is the cost breakdown by funding type and how much backlog of unfunded projects are carried forward each year; and given an expected target age of assets, what is the amount of funding required for each analysis year. An embodiment includes three sets of input parameters: objectives, budget and target age, and treatment budget allocation parameters. The objectives may include: maximize service life extension for a given budget, in this case the model optimizes the service life extension by using the given budget; and identify the budget to keep the asset age in control, in this case the model calculates the optimal budget numbers to keep the asset age/condition at a desired level, such as keeping the age constant. The budget and target age may define the available budget and target age per year. The treatment-budget allocation parameters may define the percentage of the total budget that could be assigned to the specific type of the treatment. Additional inputs may include flags that indicated that particular types of treatments should be ignored or included. An optimized asset age chart may be generated to present the results of the analysis. Depending on the objective function, this view presents a graph of the projected budget allocation, average asset age, and unfunded need per year.

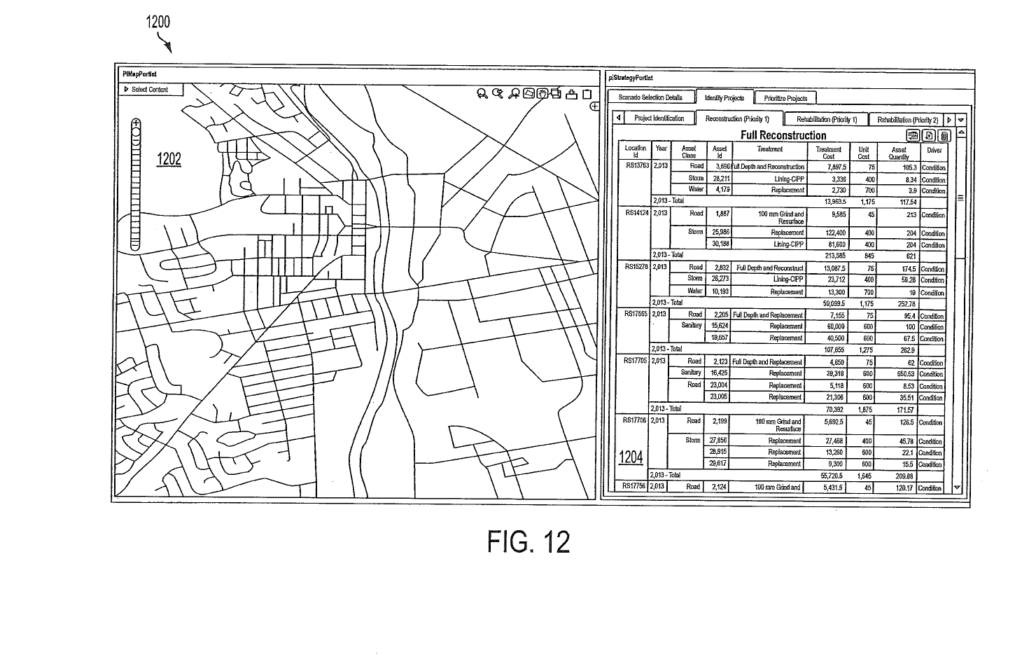

Turning now to FIG. 12, a user interface (UI) 1200 of a project identification module is generally shown in accordance with an embodiment. The project identification module allows city agencies to make a unified capital investment decision across multiple assets (road, water, storm, sewer etc.). An embodiment of the PALM tool allows cross agency business rules to be applied across each city block infrastructure to ensure cross agency coordination/project identification across different assets.

Different views of the data are shown in the embodiment of the UI 1200 in FIG. 12 including a map view 1202 and a strategy view 1204. The map view 1202 shows physical assets like road, water, storms and sewers. These are the projects that have been identified as being spatially co-located so that if one infrastructure is being worked upon, other assets can also be repaired, rehabbed or replaced. The table on the right side shows the co-located projects across road, water, storm and sewer. Each asset also has a prescription type/treatment time, cost of treatment, quantity of assets and driver for doing the project. The computation for prescriptions starts with computing the asset health scores as follows:

Listed below is pseudo code of an algorithm (Algorithm 1) for an embodiment of the factor score by time calculation. Lines 1-15 iterate through all assets, drivers, and factors defined for that asset class. Lines 2-8 calculate asset factor score by time for the non-degrading factors. In the first for loop at lines 3-5, factor score is calculated for the current year. And in the second for loop at lines 6-7, the same factor score is assigned for to future years. Lines 9-14 calculate asset factor score by time for the degrading factors. One of the inputs includes a “degraded_factor_value_{a,t}” which is calculated by applying the degradation curve to the asset factor value. At line 16, non-degrading and degrading factor scores are combined.

Algorithm 1

| | |
|---|---|
| 1 | For (a ∈ Asset_Id) and (d ∈ ST_Asset_Driver) and (f ∈ |
| | ST_Asset_Factor) { |

| | |
|---|---|
| 2 | If (f is non-degrading) { |

| | |
|---|---|
| 3 | For all (fi ∈ ST_Factor_Index_{d,f}) |

| | |
|---|---|
| 4 | If (fi.From_Range ≦ f.factor_valueₐ < fi.To_Range) |

| | |
|---|---|
| 5 | Factor_Score_Static_{a,d,f} = fi.Index_Value |

| | |
|---|---|
| 6 | For all (t ∈ Planning_Horizion) |

| | |
|---|---|
| 7 | Factor_Score_Non-Degrading_{a,d,f,t} = |
| | Factor_Score_Static_{a,d,f} |

| | |
|---|---|
| 8 | } |
| 9 | Else |
| 10 | For (t ∈ Planning_Horizion) |

| | |
|---|---|
| 11 | For (fi ∈ ST_Factor_Index_{d,f}) |

| | |
|---|---|
| 12 | If (fi.From_Range ≦ f.degraded_factor_value_{a, t} < |
| | fi.To_Range) |

| | |
|---|---|
| 13 | Factor_Score_Degrading_{a,d,f,t} = fi.Index_Value |

| | |
|---|---|
| 14 | } |

| | |
|---|---|
| 15 | } |
| 16 | Factor_Score_{a,d,f,t} = Factor_Score_Non-Degrading_{a,d,f,t} ∪ |
| | Factor_Score_Degrading_{a,d,f,t} |

In an embodiment, the driver score by time includes a value of asset score for each of the business drivers (e.g., capacity, compliance, risk, conformance to the standard) and each individual asset segment/section. The driver scores may be computed using the weighted sum of asset factors for each time intervals. An embodiment of the municipal asset management tool calculates the driver score by time as shown below.

Driver score by time may be calculated by getting the weighted average (factor weights) of the factor scores by time, as:

$${Driver\_Score}_{a , d , t} = \frac{{Σ}_{f ∈ {DF}_{d}} f . factor\_weight * {Factor\_Score}_{a , d , f , t}}{{Σ}_{f ∈ {DF}_{d}} f . factor\_weight}$$

The asset health index by time shows the overall asset score for each individual asset segment/section as a function of time. Asset scores for each asset is the weighted sum over all business drivers. In an embodiment, the asset health index by time is calculated as shown below.

Asset health index by time may be calculated by getting the weighted average (driver weights) of the driver scores by time, as:

$$Asset\_Health {\_Index}_{a , t} = \frac{{Σ}_{d ∈ {AD}_{a}} d . driver\_weight * {Driver\_Score}_{a , d , t}}{{Σ}_{d ∈ {AD}_{a}} d . driver\_weight}$$

The term “asset class” refers to a grouping by type of asset. For example, in municipalities, asset classes may include, but are not limited to, road, water, storm, and sewer. In the gas industry asset classes may include, but are not limited to, gas, pipes, and compressor stations. In the electric distribution industry asset classes may include, but are not limited to, distribution transformers, cables, circuits, and poles. In an embodiment, the asset class score represents one number for each time interval for each asset class. This the weighted sum of all assets in an asset class as a function of their length. An embodiment of the municipal asset management tool calculates the asset class score by time as shown below.

Asset class score by time may be calculated by getting the weighted average (asset quantity) of the asset health index by time, as:

$$Asset\_Class {\_Score}_{t} = \frac{{Σ}_{a ∈ Asset\_Id} a . Asset\_Quantity * Asset\_Heath {\_Index}_{a , t}}{{Σ}_{a ∈ Asset\_Id} a . Asset\_Quantity}$$

Asset prescription options by time are generated to provide prescription options for each individual asset segment/section as a function of time. These prescription options may change over time if the asset health changes. For example, if a road health is measured on a scale of 0-100 [0—worst condition 100—new road] and a road gets a score of 80 in the first year, it may become a candidate for tar and chip sealing at a cost of $10,000. In 5 years, the asset health score of the road may change to 50, in which case tar and chip sealing do not apply anymore, and instead the road becomes a candidate for a 100 mm overlay costing $50,000. An embodiment of the municipal asset management tool calculates the asset prescription options by time as shown below.

In an embodiment, the asset management database may store one or more driver score treatments (DSTs) which map assets to treatments based on driver score values. In an embodiment, the DSTs are stored in a table. Specific data fields may include a scenario identifier (e.g., a unique identifier for an execution scenario which is used for multi-scenario analysis), a treatment (treatment options, e.g., for a road may include 50 mm overlay, crack sealing, full replacement, tar and chip seal, etc.), a driver (drivers such as condition, capacity, risk, etc.), from range (a lower bound of the range for the driver score value where the treatment option should be applied), to range (an upper bound of the range for the driver score value where the treatment option should be applied).

In addition, the asset management database may store a treatment filter that identifies exclusions for the treatment options for specific conditions based on asset factor values.

Asset prescription options by time may be calculated by iterating through asset driver scores and comparing these score with the ranges defined in the DST table as shown in the algorithm below (Algorithm 2). As shown in an embodiment of the pseudo below which may be used to implement Algorithm 2, if asset driver score at time t, is in between the range for that treatment option (p), than treatment p is added to the list of treatments for that asset at time t.

Algorithm 2

For (a ∈ Asset_Id) and (d ∈ ST_Asset_Driver) {

If (DST.From_Range_{d,p} ≦ Driver_Score_{a,d,t} < DST.To_Range_{d,p}) {

Asset_Prescription_Options = Asset_Prescription_Options ∪
(a,t,p)

}

}

As shown in FIG. 12, in accordance with an embodiment, the strategy view 1204 includes three tabs: scenario selection details view, identify projects, and prioritize projects. The scenario selection details view provides the details of the scenario and it allows a user to edit/update the definition and description for the scenario. Selection of the identify projects tab allows the user to perform a multi-year analysis to combine needs across multiple assets. The analysis is performed for each asset and they are combined based on the type of projects. An embodiment of the identify projects tab includes six tabs: project identification, reconstruction (priority 1), reconstruction (priority 2), rehabilitation (priority 1), rehabilitation (priority 2), and rehabilitation (priority 3).

An embodiment of the scenario selection details includes two sections: a first section that represents scenario information (e.g., current scenario identifier, scenario name, status, create date, modify date, and description); and second section that represents the list of needs assessment scenarios to be considered for project identification (represented, for example, by a table with an entry for each assessment scenario that includes an asset class, a scenario identifier, details, and a status).

Selection of project identification in the identify projects tab in the strategy view 1204 of the UI 1200 presents a view that allow a user to perform project identification. It is used to analyze all assets in a block of road, for example, to categorize and combine assets into a project. The block level needs are combined into a project that, in an embodiment, can be one of five types of projects as described above. A project type of reconstruction (priority 1) may be selected via the identify projects tab in the strategy view 1204 of the UI 1200. A project with a type of reconstruction (priority 1) includes projects having multiple asset needs that are candidates for replacement/reconstruction in a given location. In an embodiment, these projects are displayed as a report (e.g., in the strategy view 1204) with a title of “Full Reconstruction” that includes, for each location: a location identifier, a year, an asset class, an asset identifier, a treatment, a treatment cost, a unit cost, an asset quantity, and a driver. For each location, there are at least two rows in the report representing two or more assets that are candidates for replacement or reconstruction.

Referring to FIG. 12, a project type of rehabilitation (priority 1) may be selected via the identify projects tab in the strategy view 1204 of the UI 1200. A project with a type of rehabilitation (priority 1) includes projects having only above ground needs that have good underground infrastructure. In an embodiment, these projects are displayed (e.g., in the strategy view 1204) as a report with a title of “Primary Asset Treatment Only” that includes, for each asset: a location identifier, a year, an asset class, an asset identifier, a treatment, a treatment cost, a unit cost, an asset quantity, and a driver.

Referring to FIG. 12, a project type of rehabilitation (priority 2) may be selected via the identify projects tab in the strategy view 1204 of the UI 1200. A project with a type of rehabilitation (priority 2) includes projects having above ground and some/minimal underground needs. In an embodiment, these projects are displayed (e.g., in the strategy view 1204) as a report with a title of “Primary and Secondary Asset Treatment” that includes, for each location: a location identifier, a year, an asset class, an asset identifier, a treatment, a treatment cost, a unit cost, an asset quantity, and a driver. For each location, there are at least two rows in the report representing two or more assets at the same location.

Referring to FIG. 12, a project type of reconstruction (priority 2) may be selected via the identify projects tab in the strategy view 1204 of the UI 1200. A project with a type of reconstruction (priority 2) includes projects having only below ground needs. In an embodiment, these projects are displayed (e.g., in the strategy view 1204) as a report with a title of “Reconstruction Driven by Secondary Assets” that includes, for each location: a location identifier, a year, an asset class, an asset identifier, a treatment, a treatment cost, a unit cost, an asset quantity, and a driver. For each location, there are one or more rows in the report representing one or more assets at the same location.

Referring to FIG. 12, a project type of rehabilitation (priority 3) may be selected via the identify projects tab in the strategy view 1204 of the UI 1200. A project with a type of rehabilitation (priority 3) includes projects having rehabilitation needs for underground assets. In an embodiment, these projects are displayed (e.g., in the strategy view 1204) as a report with a title of “Secondary Asset Treatment Only” that includes, for each location: a location identifier, a year, an asset class, an asset identifier, a treatment, a treatment cost, a unit cost, an asset quantity, and a driver. For each location, there are one or more rows in the report representing one or more assets at the same location.

Referring to FIG. 12, the prioritize projects tab may be selected in the strategy view 1204 of UI 1200. This view allow users to prioritize and select a subset of projects from “identified projects” based, for example, on overall budget constraints and project level budget constraints. In an embodiment, the prioritize projects tab in the strategy view has four tabs: analyze, projects, locations, and asset at location. When the analyze tab is selected, a user is prompted to define the analysis start and end year, to enter a budget for each analysis year, and the optionally the user can enter the maximum percentage of budget that should be allocated to each project type. When the projects tab is selected, a list of projects by year (e.g., project identifier, project name, and project year) is displayed in the strategy view 1204. When the locations tab is selected, location level information (e.g., project identifier, project name, project year, location identifier, location description, and project type class) is displayed, in the strategy view 1204, for each project. When the asset at locations table is selected, the details of each project (e.g., project type, project year, project identifier, project name, location identifier, asset class name, location description, cost, and asset quantity) are displayed. An embodiment shows the list of projects grouped by type of projects, and may be used to determine the locations for each project and the asset needs combined to form each project.

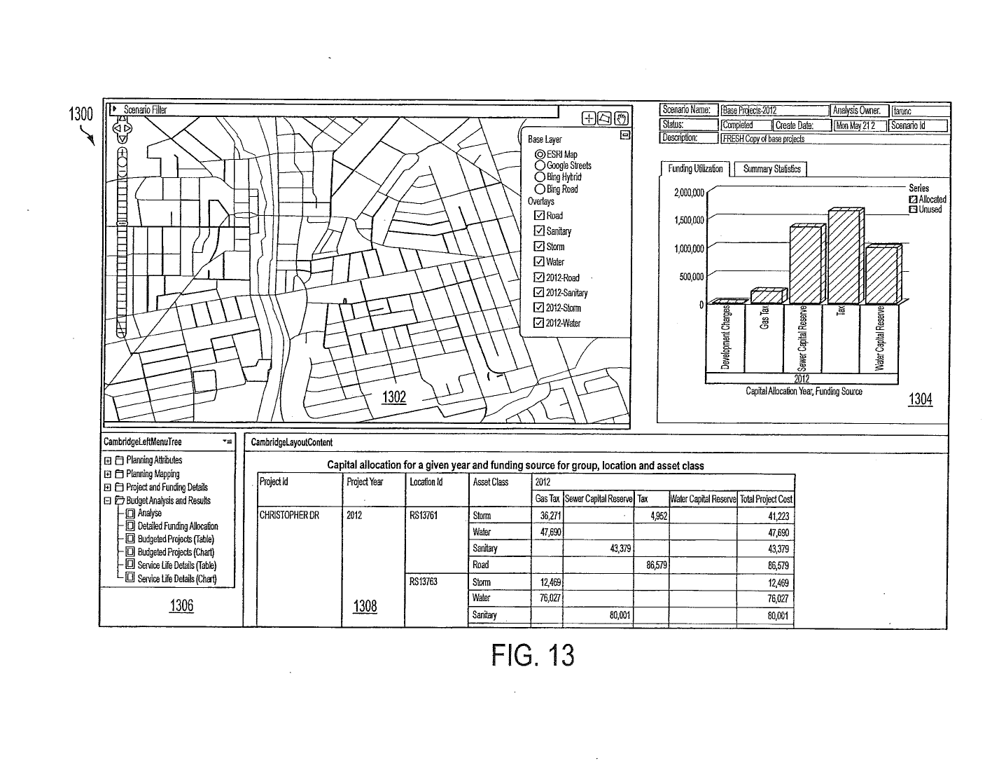

Turing now to FIG. 13, a user interface (UI) 1300 of an investment planning module is generally shown in accordance with an embodiment. Given the funding constraints, backlog of infrastructure projects and multi-year scope and multiple business goals, investment planning allows the planning department to perform scenario analysis to identify the right set of projects at the right time. This is performed using mathematical optimization to select a set of projects to maximize the return on investment (ROI). In an embodiment a user selects an existing scenario, creates a new scenario from an existing scenario or deletes a scenario. Once a scenario is selected the UI 1300 shown in FIG. 13 may be displayed. Different views of data are shown in the UI 1300 including: a map view 1302, a funding scenario view 1304, a left menu tree view 1306, and a layout view 1308. An embodiment of the map view 1302 presents the capital planning candidate projects across all asset classes. Also, once the budgeted projects are identified, the map view 1302 may present additional map layers corresponding to the selected projects.

TABLE 1
Input Data Sets

| Set Name - Set Short Name | Set Fields | Description |
|---|---|---|
| ST_Execution_Parameters - | | Tuple set containing |
| EP | | execution parameters |
| | Scenario_Id | Execution scenario |
| | Allow_Funding_Overrun | (0, 1) - Flag to allow |
| | | funding usage above the |
| | | limit |
| | Include_Exclude | (0, 1) - Flag to force |
| | | project include/exclude |
| | | requirement |
| | Maximize_RSL | (0, 1) - Flag to enable |
| | | maximizing remaining |
| | | service life as an objective |
| | Planning_Horizon_Start | Planning horizon start |
| | | year |
| | Planning_Horizon_End | Planning horizon end year |
| | Allow_Carry_Over | (0, 1) - Flag to allow |
| | | projects to be considered |
| | | at the future planning |
| | | periods (out of designated |
| | | project_year) |
| | Use_Prefered_Funding | (0, 1) - Flag to force using |
| | | preferred funding for the |
| | | designated projects |
| ST_Funding_x_Asset_Class - | | Tuple set containing |
| FA | | funding type to asset |
| | | class mapping |
| | Funding_Type | Funding types, such as gas |
| | | tax, development charges, |
| | | water tax and so on |
| | Asset_Class | Asset classes, such as |
| | | road, sanitary pipe, water |
| | | pipe and so on |
| ST_Funding_x_Driver - FD | | Tuple set containing |
| | | funding type to asset |
| | | prescription driver |
| | | mapping |
| | Funding_Type | Funding types, such as gas |
| | | tax, development charges, |
| | | water tax and so on |
| | Driver | Asset prescription driver, |
| | | such as condition, |
| | | capacity, risk and so on |
| ST_Funding_x_Project_Class - | | Tuple set containing |
| FP | | funding type to project |
| | | class mapping |
| | Funding_Type | Funding types, such as gas |
| | | tax, development charges, |
| | | water tax and so on |
| | Project_Class | Project classes, such as |
| | | replacement, |
| | | rehabilitation and so on |
| ST_Treatment_x_Asset_Class - | | Tuple set containing |
| TA | | treatment details for |
| | | asset classes. |
| | Scenario_Id | Execution scenario |
| | Asset_Class | Asset classes, such as |
| | | road, sanitary pipe, water |
| | | pipe and so on |
| | Treatment | Asset treatment types, |
| | | such as full depth and |
| | | reconstruction, |
| | | resurfacing, pipe |
| | | realigning and so on |
| | Service_Life_Extension | Asset service life |
| | | extension for the given |
| | | treatment option |
| | Service_Level_Improvement | Asset service level |
| | | (qualitative) improvement |
| | | for the given treatment |
| | | option |
| | Unit | Unit of the asset, such a |
| | | meter, meter square and |
| | | so on |
| | Unit_Cost | Cost of treatment per unit |
| | | asset |
| ST_Project - P | | Tuple set containing |
| | | project details |
| | Scenario_Id | Execution scenario |
| | Project_Id | Unique project |
| | | identification number |
| | Project_Year | Designated project year |
| | Include_Exclude | Flag (‘yes’, ‘no’) to force |
| | | project to be included or |
| | | excluded in the plan |
| ST_Location - L | | Tuple set containing |
| | | project location details |
| | | (one project may contain |
| | | multiple locations) |
| | Scenario_Id | Execution scenario |
| | Project_Id | Unique project |
| | | identification number |
| | Project_Year | Designated project year |
| | Location_Id | Unique location |
| | | identification number |
| | Preferred_Funding_Source | Preferred funding source |
| | | for the project at this |
| | | location |
| | Project_Class | Project classes, such as |
| | | replacement, |
| | | rehabilitation and so on |
| ST_Asset - A | | Tuple set containing asset |
| | | details (one location may |
| | | contain multiple assets). |
| | | Note that treatment |
| | | requirement is uncertain, |
| | | and uncertainty is |
| | | captured by |
| | | Treatment_Probability. |
| | Scenario_Id | Execution scenario |
| | Project_Id | Unique project |
| | | identification number |
| | Project_Year | Designated project year |
| | Location_Id | Unique location |
| | | identification number |
| | Asset_Class | Asset classes, such as |
| | | road, sanitary pipe, water |
| | | pipe and so on |
| | Asset_Quantity | Asset quantity, such as |
| | | area of road segment, or |
| | | length of pipe |
| | Asset_Health_Score | Asset health score (to be |
| | | used while making |
| | | investment decisions) |
| | Asset_Age | Asset age (to be used |
| | | while calculating asset |
| | | service life extention) |
| | Driver | Asset prescription driver, |
| | | such as condition, |
| | | capacity, risk and so on |
| | Treatment | Asset treatment |
| | | requirement, such as full |
| | | depth and reconstruction, |
| | | resurfacing, pipe |
| | | realigning and so on |
| | Treatment Probability | Probability of a certain |
| | | treatment being required |
| | | for this asset (uncertainty) |
| ST_Funding - F | | Tuple set containing the |
| | | funding availability |
| | Scenario_Id | Execution scenario |
| | Funding_Type | Funding types, such as gas |
| | | tax, development charges, |
| | | water tax and so on |
| | Availability_Year | Funding availability year |
| | Amount_Available | Available funding amount |

Table 1 defines an example of input data sets to an optimization model in accordance with an embodiment of the investment planning module 710. An embodiment is a computer-implemented method for stochastic investment planning. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

Another embodiment is a computer program product for stochastic investment planning. The computer program product includes a computer readable storage medium having computer readable program code embodied therewith, said program code being executable by a processor to perform a method. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

A further embodiment is a system for stochastic investment planning. The system includes a processor and an investment planning tool executable by the processor to perform a method. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

Table 2 defines an example of calculated datasets to use in the optimization model in accordance with an embodiment of the investment planning module 710. Tuples can be formed, for example, by combining project funding mapping with project-location-asset attributes.

TABLE 2
Calculated Data Sets

| Set Name - Set Short Name | Set Fields | Description |
|---|---|---|
| ST_Funding_Mapping - | | Set of tuple containing the |
| FM | | funding mapping between each |
| | | project-location-asset group to |
| | | funding type. This dataset is |
| | | calculated by combining funding |
| | | mapping datasets |
| | | (ST_Funding_x_Asset_Class, |
| | | ST_Funding_x_Driver, |
| | | ST_Funding_x_Project_Class) |
| | | and comparing these with |
| | | project-location-asset |
| | | attributes, as: |
| | | FA.Asset_Class = A.Asset_Class, |
| | | FD.Driver = A.Driver, |
| | | FP.Project_Class = L.Project_Class |
| | Project_Id | Unique project identification |
| | | number |
| | Location_Id | Unique location identification |
| | | number |
| | Asset_Class | Asset classes, such as road, |
| | | sanitary pipe, water pipe and |
| | | so on |
| | Funding_Type | Funding types, such as gas tax, |
| | | development charges, water tax |
| | | and so on |
| | Prefered_Funding_Source | If EP.Use_Prefered_Funding = 1, |
| | | then this field gets the value of |
| | | L.Preferred_Funding_Source, |
| | | else the field value is same as |
| | | Funding_Type |
| S_Planning_Horizon - T | | Set containing the time bucket |
| | | information, calculated as |
| | | EP.Planning_Horizon_Start ≦ t ≦ |
| | | EP.Planning_Horizon_End |

A number of decision variables may be defined by the optimization model to perform optimization. Examples of the decision variables include:

V_ProjectFunded_{p,t}∀pεP, tεT
Binary (0, 1) decision variables indexed over ST_Project and S_Planning_Horizon.
Gets value 1 if project p is funded at time t, and 0 otherwise.
   V_LocationFunded_{l,t} ∀lεL, tεT
Binary (0, 1) decision variables indexed over ST_Location and S_Planning_Horizon.
Gets value 1 if location 1 is funded at time t, and 0 otherwise.
   V_AssetFunded_{a,t} ∀aεA, tεT
Binary (0, 1) decision variables indexed over ST_Asset and S_Planning_Horizon.
Gets value 1 if asset a is funded at time t, and 0 otherwise.
   V_Funding_{fm,t}^{s} ∀fmεFM, tεT, sεS
Stochastic decision variables indexed over ST_Funding_Mapping and S_Planning_Horizon.
For each scenario s, captures the funding amount allocated to project-location-asset (p,l,a) group from funding type f at time t.
   V_FundingAddition_{f} ∀fεF
Decision variable indexed over ST_Funding.
Captures additional funding requirement (on top of availability) due to project Include/Exclude requirements (active if EP.Include_Exclude=1).

V_FundingOverrun_{f} ∀fεF
Decision variable indexed over ST_Funding.
Captures additional funding requirement (on top of availability) to fund all existing projects if budget constraints are relaxed (active if EP.Allow_Funding_Overrun=1).

The optimization model can be defined as a series of equations to be maximized subject to a number of constraints. In an exemplary embodiment, the optimization model may be defined as:

$$\begin{matrix} Equation \text{/} Constraint & \\ maximize {w}_{1} * {\sum }_{p ∈ P , t ∈ T} {V\_ProjectFunded}_{p , t} & 1.1 \\ + {w}_{2} * {\sum }_{s ∈ S} {p}^{s} {\sum }_{a ∈ A , t ∈ T} Service\_Life {\_Extension}_{a}^{s} * a . Asset\_Quantity * {V\_AssetFunded}_{a , t} & 1.2 \\ - {w}_{3} * {\sum }_{f ∈ F} EP . Include\_Exclude * {V\_FundingAddition}_{f} & 1.3 \\ - {w}_{4} * {\sum }_{f ∈ F} EP . Allow\_Funding \_Overrun * {V\_FundingOverrun}_{f} \\ subject to & 1.4 \\ {\sum }_{t ∈ T} {V\_ProjectFunded}_{p , t} = 0 , \\ ∀ p ∈ P \text{:} t \neq p . Project\_Year , Ep . Allow\_Carry \_Over = 0 & 2 \\ {\sum }_{t ∈ T} {V\_ProjectFunded}_{p , t} \leq 1 , \\ ∀ p ∈ P \text{:} t \geq p . Project\_Year , Ep . Allow\_Carry \_Over = 1 & 3 \\ {\sum }_{t ∈ T} {V\_ProjectFunded}_{p , t} = 0 , \\ ∀ p ∈ P \text{:} t < p . Project\_Year , Ep . Allow\_Carry \_Over = 1 & 4 \\ {V\_ProjectFunded}_{p , t} = {V\_LocationFunded}_{l , t} , \\ ∀ p ∈ P , l ∈ L , t ∈ T \text{:} p . Project\_Id = l . Project\_Id , \\ p . Project\_Year = l . Project\_Year & 5 \\ {V\_LocationFunded}_{l , t} = {V\_AssetFunded}_{a , t} , \\ ∀ l ∈ L , a ∈ A , t ∈ T \text{:} l . Project\_Id = a . Project\_Id , \\ l . Location\_Id = a . Location\_Id , \\ l . Project\_Year = a . Project\_Year & 6 \\ {V\_ProjectFunded}_{p , t} = 1 , \\ ∀ p ∈ P , t ∈ T \text{:} EP . Include\_Exclude = 1 , \\ p . Include\_Exclude = {}_{}^{′}{yes}{}_{}^{′} , \\ p . Project\_Year = t & 7 \\ {V\_ProjectFunded}_{p , t} = 0 , \\ ∀ p ∈ P , t ∈ T \text{:} EP . Include\_Exclude = 1 , \\ p . Include\_Exclude = {}_{}^{′}{no}{}_{}^{′} , \\ p . Project\_Year = t & 8 \\ {Cost}_{a}^{s} * {V\_AssetFunded}_{a , t} = {\sum }_{{fm ∈ FM \text{:}}_{{a , Project\_Id = fm . Project\_Id}_{{a . Location\_Id = fm . Location\_Id ,}_{a . Asset\_Class = fm . Asset\_Class}} ,}} {V\_Funding}_{fm , t}^{s} , \\ ∀ a ∈ A , t ∈ T , s ∈ S & 9 \\ f . Amount\_Available + EP . Include\_Exclude * {V\_FundingAddition}_{f} + EP . Allow\_Funding \_Overrun * {V\_FundingOverrun}_{f} \geq {\sum }_{{fm ∈ FM \text{:}}_{f . Funding\_Type = fm . Funding\_Type}} {V\_Funding}_{fm , t}^{s} , \\ ∀ f ∈ F , t ∈ T , s ∈ S \text{:} f . Availability\_Year = t & 10\end{matrix}$$

Equations 1.1-1.4 contain a weighted objective function of the optimization model as maximizing the number of funded projects (1.1), maximizing the service life extension (1.2), minimizing the additional (excess) funding due to mandatory projects when Include_Exclude flag is set to 1, and minimizing the additional (excess) funding if funding constraints are relaxed when Allow_Funding_Overrun flag is set to 1. Maximizing the service life extension captures the stochastic service life extension. The parameters Service_Life_Extensionₐ^{s} are calculated for each asset for each scenario.

In multi-year planning settings, constraints 2-4 guarantee that projects cannot be funded out of their designated Project_Year if Allow_Carry_Over flag is set to 0 (equation 2). Projects can be carried to the future planning years if Allow_Carry_Over flag is set to 1 (equation 3) but cannot be carried to the past planning years (no advancement) if (equation 4). Constraints 5-6 guarantee that if any project is funded, then all locations belonging to parent project (equation 5) and all assets belonging to parent location (equation 6) are completely funded. Constraints 7 forces the projects with include requirements (p.Include_Exclude=′yes′) to be funded, and constraints 8 forces the projects with exclude requirements (p.Include_Exclude=′no′) to be not funded, when Include_Exclude flag is set to 1. Constraints 9 are the stochastic funding constraints, making sure that for each scenario, projects (at asset level) are only funded through allowed funding types (funding mapping), and total asset treatment cost is funded completely. The parameters Costₐ^{s} capture the treatment cost (calculated from cost of treatment for that scenario and asset quantity) for each asset for scenario s. Constraints 10 are the budget constraints, limiting total funding to be within available funding and allowed funding extensions (due to mandatory projects or relaxed budget).

The funding scenario view 1304 in the UI 1300 of FIG. 13 presents the high level funding allocation/utilization and summary statistics associated with the selected scenario. An embodiment of the funding scenario view 1304 includes two sections: a first section that displays scenario information (e.g., current scenario identifier, scenario name, analysis owner, status, creation date, and description) and a second section that contains a funding utilization tab and a summary statistics tab. When the funding utilization tab is selected, a chart that represents the results of the budget funding utilization is presented on the UI 1300. In an embodiment, the x-axis includes the detailed breakdown of funding sources by funding year and the y-axis includes the funding allocation. Different colors may be used in the chart. For example, a green bar may be used to indicate the allocated funding and a red bar to indicate the unused funding. If a negative red bar appears, it indicates the deficit/additional funding needed for budgeted projects. Negative funding can be a result of “must do” projects or “allow funding overrun” scenarios. In an embodiment, the selection of any of the bars will show additional details for the project.

When the summary statistics tab is selected from the second section of the funding scenario view 1304, a table is presented that provides a before versus after comparison with respect to projects selected during the budgeting process. An embodiment of the table includes: business metrics (e.g. average remaining service life, remaining service multiplied by segment length, total segment length) for a before status for each of the asset classes (e.g., road, sanitary, storm, water); and business metrics (e.g., average cost per service life extension, average remaining service life, average service life extension on budgeted segments, percent improvement in remaining service life, and total service life extension multiplied by segment length) for an after status for each of the asset classes (e.g., road, sanitary, storm, water).

The layout view 1308 of the UI 1300 shown in FIG. 13 shows the content view of the detailed capital planning process. Any child node that is selected in the left menu tree view 1306, results in corresponding information (e.g., input data, output data, analysis parameter data) to be displayed in the layout view 1308. The left menu tree view 1306 of the UI 1300 of FIG. 13 is a navigation window for all steps in the capital planning process.

Several options, including asset class, project type, driver, and funding may be selected from the planning attributes menu item in the left menu tree view 1306. Selecting asset class results in a list of asset classes being displayed in the layout view 1308 of the UI 1300. Selecting project type results in a list of project type details being displayed in the layout view 1308. Selecting driver results in a list of funding drivers being displayed in the layout view 1308. Selecting funding results in a list of funding details where each row corresponds to the funding bucket being displayed in the layout view 1308. Any of the data displayed via the planning attributes menu item may be edited by users who have been given edit capability.

Options that include asset class-funding, project type-funding, driver-funding, and treatment-asset class may be selected from the planning mapping menu item in the left menu tree view 1306. Selecting asset class-funding results in a list of asset classes and associated funding type definitions being displayed in the layout view 1308. Selecting project type-funding results in a list of project types and associated funding type definitions being displayed in the layout view 1308 of the UI 1300. Selecting planning mapping-driver funding results in a list of driver names and associated funding type definitions being displayed in the layout view 1308 of the UI 1300. Selecting planning treatment-asset class results in a list of treatments, asset class names and associated additional service life for the asset class if the treatment is applied being displayed in the layout view 1308 of the UI 1300. Any of the data displayed via the planning mapping menu item may be edited by users who have been given edit capability. In addition, the lists may include multiple instances of the same data (e.g., each driver condition may be associated with several funding types such as tax, gas tax, and development charges; and each funding type may be associated with several driver conditions).

Options that include projects, locations, assets at locations, and funding sources may be selected from the project and funding details menu item in the left menu tree view 1306 of the UI 1300 of FIG. 13. Selecting projects results in a list of projects (e.g., with columns for project identifier, project name, project year, include/exclude, and capital allocation year) being displayed in the layout view 1308 of the UI 1300. Users can force a project to be included into the budget by entering a “Y” in the include/exclude column. Alternatively, a project can be barred from being considered by entering a “N” in the include/exclude column. Once the capital plan is finalized, the capital allocation year column shows the budgeted year. Projects can be added, deleted, updated, and copied by users. Selecting locations from the project and function details menu item in the left menu tree view 1306 of the UI 1300 of FIG. 13 results in a list of locations being displayed in the layout view 1308. Each project can have more than one location and an embodiment of each entry in the list includes columns for project identifier, project name, project year, location identifier, preferred funding source, location description, and project type. Locations can be added and deleted by users.

Referring to FIG. 13, selecting assets at locations from the project and funding details menu item in the left menu tree view 1306 of the UI 1300 results in a detailed breakdown of assets in the location being displayed in the layout view 1308. For each asset the detailed breakdown may include columns for project identifier, project name, project year, location identifier, location description, asset class name, asset quantity, asset cost, asset quantity, renewal type, current service life, and condition index. Assets at locations (and their corresponding information) may be added and deleted by users.

Referring to FIG. 13, selecting funding sources from the project and funding details menu item in the left menu tree view 1306 of the UI 1300 results in a list of funding sources being displayed in the layout view 1308. For each funding source the list may include columns for funding type, availability year, and amount available. Funding sources may be added and deleted by users.

Options that include analyze, detailed funding allocation, budgeted projects (table), budgeted projects (chart), service life details (table) and service life details (chart) may be selected from the budget analysis and results menu item in the left menu tree view 1306 of the UI 1300 of FIG. 13. Selecting analyze allows the user to perform budget analysis. Several options may be available: allow funding overrun, force include/exclude requirements, allow project carryover from the past, allow project carryover within the planning horizon, and use only preferred funding. The option allow funding overrun option allows for running an optimization instance without applying the budget constraints. If this option is set to yes, then the system will not take the budget funding amounts into account. Not applying budget amounts will allow the model to select all projects and allow the user to identify the budget shortfall to execute all projects. The force include/exclude requirements option forces projects to be included/excluded if the value is set to yes. In an embodiment, this option will apply the user assignment on the projects tab in the include/exclude column. The allow project carryover from the past option, allows, when the flag is set to yes, projects from the past year (before the planning horizon start) to be considered as potential candidates in the budgeting process. The allow project carryover within planning horizon option, allows, when the flag is set to yes, projects within the planning horizon to be considered as candidates for future years within the planning horizon. For example, if a project is assigned 2014 as the potential date, and the planning horizon is 2013-2016, this project will be considered as a candidate for 2015 and 2016. If this option is set to no, then the project will only be considered for the assigned year. The use only preferred funding option allows only preferred funding sources to be considered as candidates.

User selectable options are available from the layout view 1308 of the UI 1300 when analyze has been selected from the budget analysis and results menu item in the left menu tree view 1306. The options may include: analyze (selection of this button kicks off the budget optimization process, if a parameter has changed, the analyze will only take it into consideration if the update button has been selected); update (by selecting this button a user can update the input parameters to run the model); and finalize (by selecting this button, the budgeted projects are copied back to the projects—capital allocation year which finalizes the scenario so that no change can take effect).

Referring to FIG. 13, selecting detailed funding allocation from the budget analysis and results menu item in the left menu tree view 1306 of the UI 1300 results in a list showing the capital allocation for a given year and funding source for group, locations, and asset class being displayed in the layout view 1308. An embodiment of the list may include columns for project identifier, project year, location identifier, asset class and year. Then within the year, the list may include columns for development charges, gas tax, sewer capital reserve, tax, water capital reserve, and total project cost.

Referring to FIG. 13, selecting budgeted projects (table) from the budget analysis and results menu item in the left menu tree view 1306 of the UI 1300 results in a list (e.g., a table) that shows the dollar cost per service life extension for each group, location, and asset. In general, lower cost projects are more attractive investments than high cost projects. An embodiment of the table may include columns for project identifier, project year, include/exclude location identifier, year, and total cost. Then within the year, the list may include columns for road, sanitary, storm, and water. Selecting budgeted projects (chart) from the budget analysis and results menu item in the left menu tree view 1306 of the UI 1300 results in a bar chart showing the average cost per service life extension.

Referring to FIG. 13, selecting service life details (table) from the budget analysis and results menu item in the left menu tree view 1306 of the UI 1300 results in a list (e.g., a table) that shows the service life extension of assets (number of years added multiplied by length). An embodiment of the table may include columns for project identifier, project year, location identifier, and year. Then within the year, the list may include columns for road, sanitary, storm, and water. Selecting service life details (chart) from the budget analysis and results menu item in the left menu tree view 1306 of the UI 1300 results in a line chart showing the service life extension by capital allocation year and asset class name.

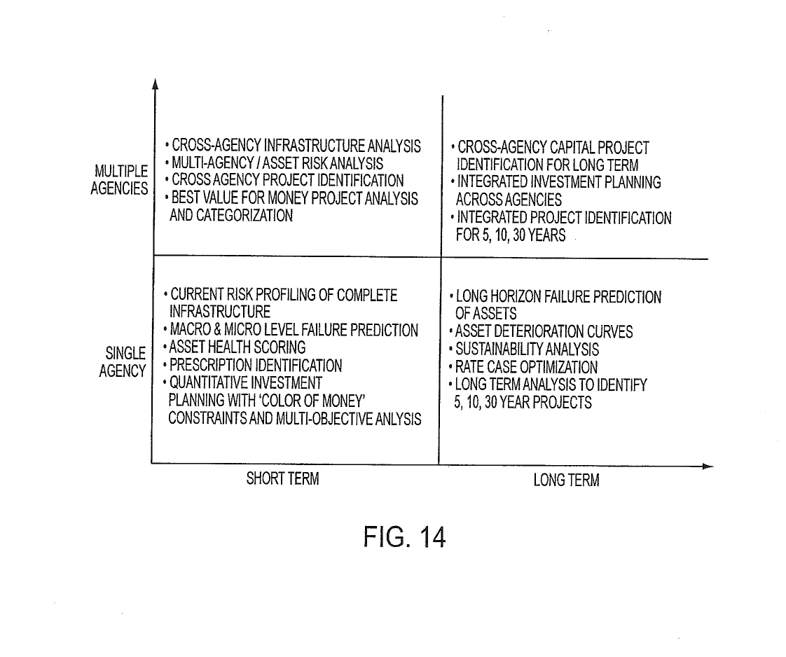

Turning now to FIG. 14, actions performed by embodiments described herein are shown and placed in quadrants based on whether they are performed by a user for single agency or for multiple agencies, and whether they are performed as part of short term planning or long term planning. The use of an embodiment of the PALM tool described herein may result in substantial savings to municipalities over the life of their assets. Sources of the savings may include, but are not limited to: cross-agency asset data into is located in one system to enable cross-agency cost takeout and increase cross-agency coordination; reduced time to analyze data from months to days; substantially reduce the time taken to prepare capital plans; get a view into future condition of assets, failure probability to minimize reactive/emergency maintenance; hard code key business, operational and financial rules into system in order to get consistency over years of planning; align cross agency projects in order to minimize “digging the street twice”; analyze multiple modeling scenarios in order to arrive at optimal planning and financial decisions; reduce the yearly capital planning process from months to days; easily get a 5 to 50 year view that allows council and management to plan strategy, policy and taxes; and allows strong cases to be made to city council by providing needed facts easily.

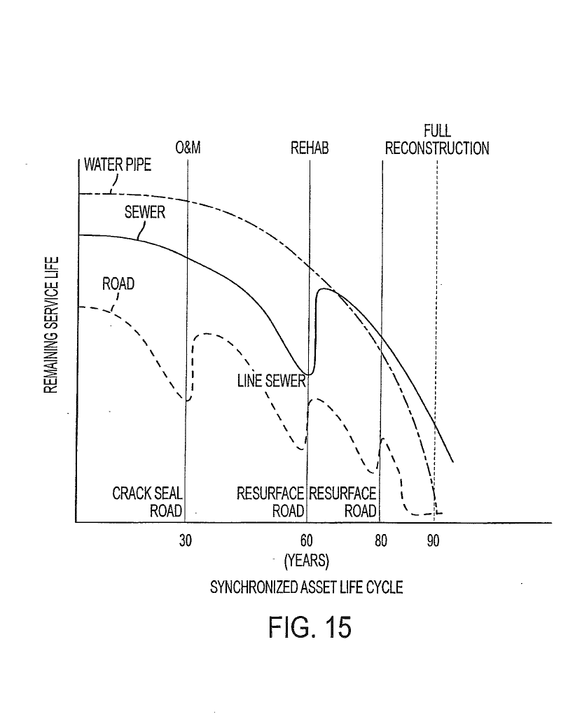

Embodiments may be used to synchronize asset lifecycles so that asset replacement in staggered. See for example, FIG. 15, which shows the lifecycle for roads, sewers and storm pipes. As the assets age and go through deterioration in service levels, maintenance and rehabilitation are performed on them. The ability to synchronize the end of life of assets may be important to ensuring that these assets are replaced together as a unit rather than individually.

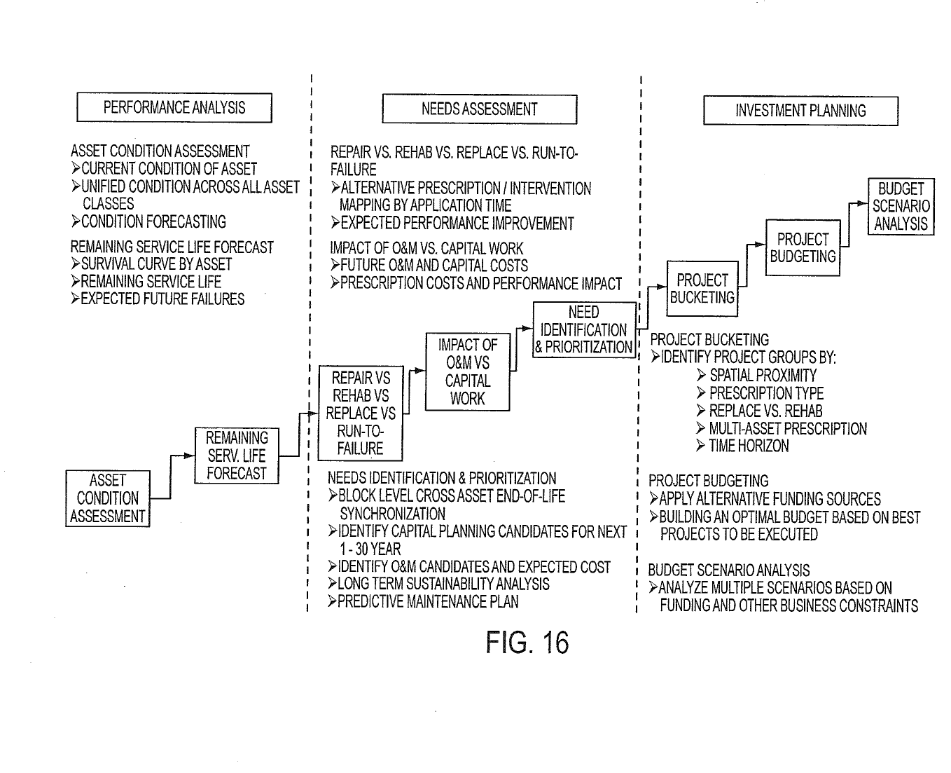

Turning now to FIG. 16, the underlying analytics that provide descriptive, predictive, and prescriptive insights at each phase of decision making when using an embodiment of the PALM too are generally shown.

Technical effects and benefits include efficiency in operation due to embodiments of the PALM tool streamlining capital planning efforts by standardizing, aligning and automating processes. In addition, an increase in cross-agency coordination by aligning projects into one system may lead to efficiencies in management. In addition, extensive cost saving opportunities exist when using the PALM tool, due for example, to predictive performance analysis that creates a unified health index for each asset which allows cities to efficiently identify, prioritize, replace, and rehabilitate city assets; and to a reduction in the number of resources allocated to the capital budgeting process. Further, strategic planning may be streamlined due to being able to easily determine optimal planning and financial decisions by analyzing multiple modeling scenarios, to decisions being able to be made with a more comprehensive understanding of current and future asset needs; and achieving long-term consistent planning through flexible business, operational and financial rules. Still further, the PALM tool support an open and consistent budget plans which are transparent and adhere to government standards and regulations.

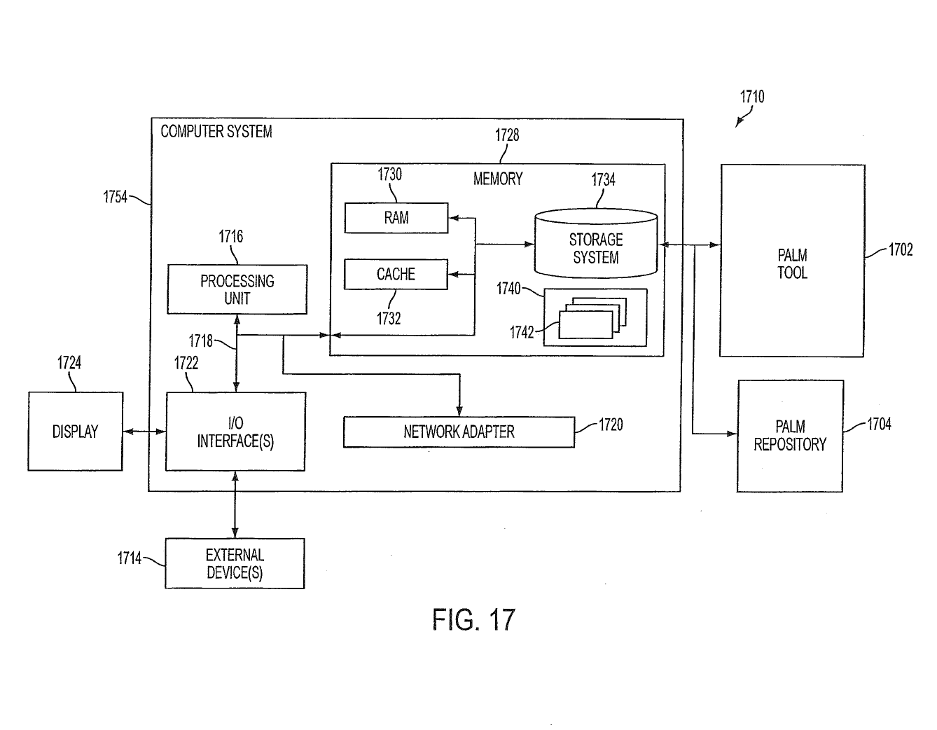

Referring now to FIG. 17, a schematic of an example of a computer system 1754 in a network environment 1710 is shown. The computer system 1754 is only one example of a suitable computer system and is not intended to suggest any limitation as to the scope of use or functionality of embodiments of the invention described herein. Regardless, computer system 1754 is capable of being implemented and/or performing any of the functionality set forth hereinabove.

In network environment 1710, the computer system 1754 is operational with numerous other general purpose or special purpose computing systems or configurations. Examples of well-known computing systems, environments, and/or configurations that may be suitable as embodiments of the computer system 1754 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 1754 may be described in the general context of computer system-executable instructions, such as program modules, being executed by one or more processors of the computer system 1754. Generally, program modules may include routines, programs, objects, components, logic, data structures, and so on that perform particular tasks or implement particular abstract data types. Computer system 1754 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 17, computer system 1754 in network environment 1710 is shown in the form of a general-purpose computing device. The components of computer system 1754 may include, but are not limited to, one or more computer processors or processing units 1716, a system memory 1728, and a bus 1718 that couples various system components including system memory 1728 to processor 1716.

Bus 1718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 1754 typically includes a variety of computer system readable media. Such media may be any available media that is accessible by computer system 1754, and it includes both volatile and non-volatile media, removable and non-removable media.

System memory 1728 can include computer system readable media in the form of volatile memory, such as random access memory (RAM) 1730 and/or cache memory 1732. Computer system 1754 may further include other removable/non-removable, volatile/non-volatile computer system storage media. By way of example only, storage system 1734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1718 by one or more data media interfaces. As will be further depicted and described below, memory 1728 may include at least one program product having a set (e.g., at least one) of program modules that are configured to carry out the functions of embodiments of the invention.

Program/utility 1740, having a set (at least one) of program modules 1742, may be stored in memory 1728 by way of example, and not limitation, as well as an operating system, one or more application programs, other program modules, and program data. Each of the operating system, one or more application programs, other program modules, and program data or some combination thereof, may include an implementation of a networking environment. Program modules 1742 generally carry out the functions and/or methodologies of embodiments of the invention as described herein. An example application program or module is depicted in FIG. 17 as web browser 1700, including PALM tool 1702 which includes logic that is configured to generate, access, and update PALM repository 1704 for an associated user. In an embodiment, the PALM tool 1702 in stored in the system memory 1728 and may be executed within a web browser. The PALM repository 1704 can be stored in storage system 1734 or in other portions of system memory 1728. Alternatively, the PALM repository 1704 may be stored elsewhere in the network environment 1710. The PALM repository 1704 is used herein as one example of a location where the planning data may be stored, it is not intended to imply that a database system is required as the planning data used by the PALM tool 1702 may be stored in any manner that allows types of accesses described herein. In an embodiment, all or a portion of the planning repository 806 shown in FIG. 8 is included in the PALM repository 1704.

Computer system 1754 may also communicate with one or more external devices 1714 such as a keyboard, a pointing device, a display device 1724, etc.; one or more devices that enable a user to interact with computer system 1754; and/or any devices (e.g., network card, modem, etc.) that enable computer system 1754 to communicate with one or more other computing devices. Such communication can occur via input/output (I/O) interfaces 1722. Still yet, computer system 1754 can communicate with one or more networks such as a local area network (LAN), a general wide area network (WAN), and/or a public network (e.g., the Internet) via network adapter 1720. As depicted, network adapter 1720 communicates with the other components of computer system 1754 via bus 1718. It should be understood that although not shown, other hardware and/or software components could be used in conjunction with computer system 1754. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for asset lifecycle management, the method comprising:
assessing a current health condition of a plurality of assets that are managed by a plurality of different entities;
applying predictive analytics to determine a predicted future health condition of the assets;
determining prescription options for the assets based on the current health condition and the predicted future health condition of the assets, each prescription option specifying an asset, a timeframe, an expected cost, and an expected future health condition of the asset;
performing spatial and temporal analytics to combine individual prescription options into a unified project, the unified project including prescription options that specify assets that are managed by at least two of the entities;
determining a timeframe to execute the unified project, the determining based on financial constraints and spatial constraints; and
outputting the unified project plan.

2. The method of claim 1, wherein performing the spatial analytics includes combining the individual prescription options into the unified project based on at least one of spatial overlap and spatial proximity of assets specified the individual prescription options.

3. The method of claim 1, wherein the current health condition of the assets includes at least one of remaining service life and failure probability of the assets.

4. The method of claim 1, wherein the predicted future health condition of the assets includes at least one of remaining service life and failure probability of the assets for a selected point in time.

5. The method of claim 1, wherein the assets are city infrastructure assets including both above and below ground assets.

6. The method of claim 5, wherein performing the temporal analytics includes temporally aligning, in the unified project plan, a prescription option that specifies a below ground asset prior to a prescription option that specifies an above ground asset.

7. The method of claim 1, wherein the assets are city infrastructure assets including both linear and point assets.

8. The method of claim 1, wherein the entities are city agencies.

9. The method of claim 1, wherein determining the timeframe is further based on at least one of business, quality, social, and political constraints.
